(19) United States
(12) Patent Application Publication
(10) Pub. No.: US 2009/0030403 A1
(43) Pub. Date: Jan. 29, 2009

(54) Methods and Systems for Attenuating the Tolerance Response to a Drug

(76) Inventor: Kent W. Leyde, Sammamish, WA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/829,821

(22) Filed: Jul. 27, 2007

(51) Int. Cl. G06F 19/00

(52) U.S. Cl. 604/890.1

(57) ABSTRACT

Methods are provided for modulating a drug response comprising determining that a patient has an elevated or reduced susceptibility for a neurological event; outputting a signal that indicates to the patient to administer an acute dosage of a pharmacological agent that is sufficient to modulate the patient's susceptibility for the neurological event, wherein the drug response is modulated. Systems are also provided for treating epilepsy comprising an electrode array configured to receive a signal from a patient; a processing assembly configured to receive and process the signal to determine the patient's susceptibility for a neurological event; an output assembly configured to produce an output that indicates to the patient to administer an acute dosage of a pharmacological agent that is sufficient to reduce the patient's susceptibility for the neurological event, wherein the drug response to the pharmacological agent is attenuated.

### CROSS REFERENCE TO RELATED APPLICATIONS

The present invention is related to U.S. patent application Ser. No. 11/321,898, entitled “Methods and systems for recommending an appropriate pharmacological treatment to a patient for managing epilepsy and other neurological disorders,” filed Dec. 28, 2005, to DiLorenzo et al. (BNC Reference No. 2.01US; WSGR Docket No. 31685-713.202), U.S. patent application Ser. No. 11/321,897, entitled “Methods and systems for recommending an appropriate action to a patient for managing epilepsy and other neurological disorders,” filed Dec. 28, 2005, to Leyde et al. (BNC Reference No. 2.01US; WSGR Docket No. 31685-713.201), U.S. patent application Ser. No. 11/322,150, entitled “Systems and methods for characterizing a patient's propensity for a neurological event and for communicating with a pharmacological agent dispenser,” filed Dec. 28, 2005, to Bland et al., (BNC Reference No. 2.02US; WSGR Docket No. 31685-713.203), and U.S. Provisional Patent Application Ser. No. 60/743,294, entitled “Methods and systems for administering an appropriate pharmacological treatment to a patient for managing epilepsy and other neurological disorders,” filed Feb. 14, 2006, to DiLorenzo (BNC Reference No. 2.03P; WSGR Docket No. 31685-716.101), the complete disclosures of which are incorporated herein by reference.

### FIELD

The present invention relates generally to modulating the response of drug tolerance to a drug by characterizing a patient's susceptibility or propensity for a future neurological event and having the patient respond with some action such as take an acute dosage of the drug or modify a chronic drug regimen.

### BACKGROUND

Epilepsy is a disorder of the brain characterized by chronic, recurring seizures. Seizures are a result of uncontrolled discharges of electrical activity in the brain. A seizure typically manifests as sudden, involuntary, disruptive, and often destructive sensory, motor, and cognitive phenomena. Seizures are frequently associated with physical harm to the body (e.g., tongue biting, limb breakage, and burns), a complete loss of consciousness, and incontinence. A typical seizure, for example, might begin as spontaneous shaking of an arm or leg and progress over seconds or minutes to rhythmic movement of the entire body, loss of consciousness, and voiding of urine or stool.

A single seizure most often does not cause significant morbidity or mortality, but severe or recurring seizures (epilepsy) results in major medical, social, and economic consequences. Epilepsy is most often diagnosed in children and young adults, making the long-term medical and societal burden severe for this population of patients. People with uncontrolled epilepsy are often significantly limited in their ability to work in many industries and cannot legally drive an automobile. An uncommon, but potentially lethal form of seizure is called status epilepticus, in which a seizure continues for more than 30 minutes. This continuous seizure activity can lead to permanent brain damage, and can be lethal if untreated.

While the exact cause of epilepsy is uncertain, epilepsy can result from head trauma (such as from a car accident or a fall), infection (such as meningitis), or from neoplastic, vascular or developmental abnormalities of the brain. Most epilepsy, especially most forms that are resistant to treatment (i.e., refractory), are idiopathic or of unknown causes, and is generally presumed to be an inherited genetic disorder. Demographic studies have estimated the prevalence of epilepsy at approximately 1% of the population, or roughly 2.5 million individuals in the United States alone.

While there is no known cure for epilepsy, chronic usage of anticonvulsant and antiepileptic medications can control seizures in most people. The anticonvulsant and antiepileptic medications do not actually correct the underlying conditions that cause seizures. Instead, the anticonvulsant and antiepileptic medications manage the patient's epilepsy by reducing the frequency of seizures. There are a variety of classes of antiepileptic drugs (AEDs), each acting by a distinct mechanism or set of mechanisms.

It has been estimated that an “average” patient with focal epilepsy has a seizure frequency of about three seizures per month, in which the total time the patient is having a seizure is about less than two hours per year. This means that approximately 99.97% of the patient's life is seizure free. Nonetheless, most clinicians recommend chronic medications for treatment of their patient's epilepsy. AEDs generally suppress neural activity by a variety of mechanisms, including altering the activity of cell membrane ion channels and the propensity of action potentials or bursts of action potentials to be generated. These desired therapeutic effects are often accompanied by the undesired side effect of sedation. Some of the fast acting AEDs, such as benzodiazepine, are also primarily used as sedatives. Other medications have significant non-neurological side effects, such as gingival hyperplasia, a cosmetically undesirable overgrowth of the gums, and/or a thickening of the skull, as occurs with phenyloin. While chronic usage of AEDs has proven to be effective for a majority of patients suffering from epilepsy, the persistent side effects can cause a significant impairment to a patient's quality of life.

Furthermore, as with many types of drugs, the classes of drugs used for controlling seizures may only be effective for a limited amount of time. This is due to the acquired tolerance response that many patients present after an extended period of exposure to one or more antiepileptic drugs. The term “acquired tolerance,” as used herein, refers to the reduction in response to a drug after one or more administrations. This reduction can necessitate an increase of dosage of a drug, the combination of the drug with other drugs, alternative treatment strategies or withdrawal from the drug until the patient's responsiveness to the drug returns. Tolerance to antiepileptic drugs poses major health and financial issues for a patient suffering from epilepsy.

It would be a great advantage to a patient suffering from epilepsy to be able to prevent acquired tolerance or to extend the length of time it takes for his or her body to become tolerant to an antiepileptic drug.

### SUMMARY OF THE INVENTION

In one aspect, the present invention provides a method of modulating a drug response. The method comprises determining that a patient has an elevated susceptibility for a neurological event and outputting a signal that indicates to the patient to administer an acute dosage of a pharmacological agent that is sufficient to modulate the patient's susceptibility for the neurological event, wherein the patient's drug response is modulated. The drug response may be tolerance and/or side effects.

In another aspect, the present invention provides a system for treating epilepsy. The system comprises an electrode array configured to receive a signal from a patient. A processing assembly is in communication with the electrode array and is configured to receive and process the signal from the electrode array to determine the patient's susceptibility for a neurological event. An output assembly is configured to produce an output that indicates to the patient to administer an acute dosage of a pharmacological agent that is sufficient to reduce the patient's susceptibility for the neurological event, wherein the drug response (e.g., tolerance and/or side effect(s)) to the pharmacological agent is attenuated.

In a further aspect, the present invention provides a method of modulating a drug response. The method comprises determining that a patient has an elevated susceptibility for a neurological event and outputting a signal that indicates to the patient to adjust a dosage of a chronically taken pharmacological agent that is sufficient to modulate the patient's susceptibility for the neurological event, wherein the drug response is modulated.

In another aspect, the present invention provides a system for treating epilepsy. The system comprises an electrode array configured to receive a signal from a patient. A processing assembly is in communication with the electrode array and is configured to receive and process the signal to determine the patient's susceptibility for a neurological event. An output assembly is configured to produce an output that indicates to the patient to administer an adjusted dosage of a chronically taken pharmacological agent that is sufficient to reduce the patient's susceptibility for the neurological event, wherein the drug response to the pharmacological agent is attenuated.

In yet another aspect, the present invention provides a method of treating epilepsy. The method comprises estimating a patient's neurological condition and determining if the patient's estimated condition is in a contra-ictal condition. When the patient is not in the contra-ictal condition, a signal is output that indicates to a patient to administer one or more acute dosage(s) of a pharmacological agent that is sufficient to modulate the patient's neurological condition, wherein the patient's susceptibility for a seizure is attenuated. In addition to the acute dosage(s) of the pharmacological agent, the patient may take a chronic pharmacological agent to maintain the patient in a contra-ictal condition.

The pharmacological agent used in the methods and systems described herein may be an anti-epileptic agent and the neurological event may be an epileptic seizure. Of course, the neurological event could be other types of episodic neurological events, such as tremors, migraine headaches, etc. and other types of pharmacological agents may be used.

Some useful pharmacological agents include, but is not limited to a compound that modulates the sodium channels of a cell; a compound that modulates the sodium currents of a cell; a compound that modulates the calcium channels of a cell; a compound that modulates the calcium currents of a cell; a compound that modulates the potassium channels of a cell; a compound that modulates the potassium currents of a cell; a compound that modulates glutamic acid decarboxylase; a compound that binds to a gamma-aminobutyric acid receptor site; a compound that inhibits the metabolism of gamma-aminobutyric acid; a compound that inhibits the reuptake of gamma-aminobutyric acid; a compound that binds to a glutamate binding site; a compound that binds to an alpha-amino-3-hydroxy-5-methylisoxazole-4-propionic acid (AMPA) binding site; a compound that binds to a kainate binding site; a compound that binds to an N-methyl-D-aspartate (NMDA) binding site; a compound that binds to a glycine binding site; a compound that binds to a metabotropic binding site; a compound that is a natural or synthetic hormone; a compound that inhibits carbonic anhydrase; or a combination thereof.

Some specific agents include a barbiturate, hydantoin, oxazolidinedione, succinimide, benzodiazepine, carboxamide, fatty acid derivative, fructose derivative, carboxylic acid, GABA analog, monosaccharide, aromatic allylic alcohol, urea, triazine, phenyltriazine, carbamate, pyrrolidine, pyrimidinedione sulfonamide, valproic acid, valproate, valproylamide, propionate, aldehyde, bromide, Barbexaclone, Metharbital, Methylphenobarbital, Phenobarbital, Primidone, Ethotoin, Fosphenyloin, Mephenyloin, Phenyloin, Ethadione, Paramethadione, Trimethadione, Ethosuximide, Mesuximide, Phensuximide, Clobazam, Clonazepam, Clorazepate, Diazepam, Lorazepam, Midazolam, Nitrazepam, Temazepam, Carbamazepine, Oxcarbazepine, Rufinamide, Valpromide, Valnoctamide, Valproic acid, Sodium Valproate, Valproate Semisodium, Tiagabine, Gabapentin, Pregabalin, Progabide, Vigabatrin, Topiramate, Stiripentol, Phenacemide, Pheneturide, Lamotrigine, Emylcamate, Felbamate, Meprobamate, Brivaracetam, Levetiracetam, Nefiracetam, Seletracetam, Acetazolamide, Ethoxzolamide, Sultiame, Methazolamide, Zonisamide, Beclamide, Paraldehyde, Potassium Bromide, Divalproex Sodium, Ganaxolone, Huperzine A, JZP-4, Lacosamide (SPM 927), NS1209, Retigabine, RWJ 333369, Talampanel, Eslicarbazepine acetate, Fluorofelbamate, Propylisopropyl acetamide, Valrocemide or a combination thereof.

For a further understanding of the nature and advantages of the present invention, reference should be made to the following description taken in conjunction with the accompanying drawings.

### BRIEF DESCRIPTION OF THE DRAWINGS

FIG. 1 is a diagram of the potential model of the disclosed device in maximizing the attenuation of a tolerance response.

FIG. 2 is a diagram of the potential asymptotic model of the attenuated tolerance response with use of the disclosed device.

FIG. 3 is a diagram of the potential model of the gradual return toward the control level of tolerance using the disclosed device.

FIG. 4 is a diagram of another potential model of the gradual return to the control level of tolerance using disclosed device.

FIG. 5 is a diagram of yet another potential model of the gradual return toward the control level of tolerance using the disclosed device.

FIG. 6 is a diagram of a hypothetical data comparison of the number of seizures a patient could have without AED intervention to the potentially reduced number of seizures that a patient could experience with the use of one or more AED's to the potentially further reduced number of seizures that a patient may experience when using one or more AED's with the disclosed device.

FIG. 7 is a flowchart of a prediction method.

FIG. 8 is a block diagram illustrating aspects of feature extractors and classifiers.

FIG. 9 is a 2-dimensional projection of various ictal feature vectors.

FIG. 10 is an example of a classifier output.

FIG. 11 is a simplified diagram of a truth table that may be used to determine an output communication to the patient.

FIG. 12 is a simplified diagram of a system that may be used to monitor the patient's condition.

FIG. 13 is a block diagram of an implanted communication unit that may be used in accordance with the systems and methods described herein.

FIG. 14 is a block diagram of an external data device that may be used in accordance with the systems and methods described herein.

### DETAILED DESCRIPTION

A. Introduction and General Overview

The present invention provides improved systems and methods for attenuating the tolerance response to one or more drugs by monitoring, managing, and treating neurological disorders and communicating with a patient that indicates an appropriate action to manage their condition. The systems and methods of the present invention are typically configured to characterize a patient's susceptibility or propensity for a future neurological event. This process of monitoring the propensity of a neurological condition to occur reduces the need for constant, prophylactic dosages of medication of the patient and limits the tolerance response of the patient to the activity of one or more drugs by providing dosages of the drug only when it is needed. Furthermore, if it is desired to continue the prophylactic dosages of the medication, the present invention provides methods and systems that allows for titration of the patient's drugs so that the dosages are adjusted to compensate for the patient's change in susceptibility to the neurological condition. Such methods also act to reduce the tolerance response of the patient to the activity of one or more drugs.

In preferred aspects, the present invention is for modulating a response to a drug, especially those used for managing epilepsy—including the prevention or reduction of the occurrence of epileptic seizures and/or mitigating their effects. The method of preventing an epileptic seizure comprises characterizing a patient's susceptibility or propensity for a future seizure (or otherwise predicting a future seizure), and upon the determination that the patient has an elevated propensity for the seizure, communicating to the patient and/or a health care provider a warning or therapeutic recommendation. Such a method would allow for acute dosages of medication and/or the titration, reduction, or stoppage of constant, prophylactic medication.

The communication provided to the patient can provide a prompt, recommendation, or instruction to: (1) take an acute dosage of a specified pharmacological agent (e.g., neurosuppressant, sedative, AED or anticonvulsant), (2) adjust the timing or dosage of a chronically prescribed pharmacological agent, (3) perform a specific action such as assuming a safe posture or position, activate an implanted drug dispenser, (4) manually activate a neuromodulation treatment such as vagus nerve stimulation (VNS), deep brain stimulation (DBS), cortical stimulation, or (5) make one or more behavioral modifications (e.g., of lying down, turning off lights, interrupting working, touching the face, hyperventilating, hypoventilating, holding breath, performing a valsalva maneuver, applying external stimulator, applying transcutaneous electrical or magnetic neural stimulation, and other action or cessation of activity. In other embodiments, however, the therapy can be automatically administered to the patient and the patient can be notified about the therapy via a communication.

The systems of the present invention can optionally store and/or utilize communications supplied by a patient or caregiver such as confirmation that a medication has been taken, that the patient is going to bed, that the patient has awoken, that the patient is experiencing an aura, or the like. This information can in turn used by the system in subsequent calculations of the patient's propensity for a seizure.

In preferred aspects, the communication, instructions, or recommendations provided by the systems and methods of the present invention will be a reflective of, or a function of, the patient's propensity for the future seizure, which is typically at least partially derived from analysis of the physiological signals, or some other determination of the patient's risk of a seizure. Consequently, depending on what the clinician determines to be appropriate actions for the particular patient, a customized recommendation can be provided to the patient. For example, if the propensity for a future seizure is indicative of a long time horizon or a low likelihood of a seizure, the recommendation or instruction for treatment communicated to the patient will be reflective of the low risk/long time horizon. On the other hand, if the prediction of the seizure is indicative of a short time horizon or a high likelihood of a seizure, the recommendation or instruction for treatment to the patient will be reflective of such a prediction. Thus, in the case of a long prediction time horizon or a low probability of a seizure, a smaller than “normal” dose of a relatively slower onset antiepileptic drug or an antiepileptic drug with a lower side effect profile can be some of the appropriate therapies recommended by the clinician. In contrast, for a short prediction horizon or a high probability of a seizure, a higher than “normal” dosage of a faster acting drug, such as a sublingual, buccal, intranasal, intramuscular, or intravenous dose of a benzodiazepine, can be some of the appropriate actions recommended by the clinician.

In one specific aspect, the present invention provides a system that comprises a predictive algorithm that is configured to be used in conjunction with acute dosages of a pharmacological agent, including an AED, such as the rapid onset benzodiazepines. Other antiepileptic drugs or sedatives can be used as well. The predictive algorithm can be used to characterize a patient's propensity for the seizure. If the predictive algorithm determines that the patient has an elevated propensity for an epileptic seizure or otherwise predicts the onset of a seizure, the system can provide an output that prompts, recommends or instructs the patient to take an acute dosage of a pharmacological or therapeutic agent (such as an AED) to prevent the occurrence of the seizure or reduce the magnitude or duration of the seizure.

Unlike conventional antiepileptic drug treatments, which provide for a chronic regimen of pharmacological agents, the present invention is able to manage seizures acutely while substantially optimizing the intake of the pharmacological agent by instructing the patient to take a pharmacological agent only when it is determined that a pharmacological agent is necessary, thereby attenuating the tolerance response. Furthermore, with this new paradigm of seizure prevention, the present invention provides a new indication for pharmacotherapy. This new indication is served by several existing medications, including AEDs, given at doses which are sub-therapeutic to their previously known indications, such as acute AED administration for seizure termination or status epilepticus. Since this new indication is served by a new and much lower dosing regimen and consequently a new therapeutic window, the present invention is able to provide a correspondingly new and substantially reduced side effect profile and a reduced tolerance response—which may further increase the length of efficacy of the AEDs.

For example, the present invention allows the use of dosages that are lower than FDA-approved dosages for the various anti-epileptic agents. This dosing can be about 5% to about 95% lower than the FDA-recommended dose for the drug, and preferably at or below 90% of the FDA-recommended dose, and most preferably below about 50% of the FDA-recommended dose, below about 25% of the FDA-recommended dose, below about 10% of the FDA recommended dose, or below about 5% of the FDA recommended dose. But as can be appreciated, if the measured signals indicate a high risk for a seizure, the methods and systems of the present invention can recommend taking the FDA approved dose or a higher than FDA approved dose of the AED to prevent the predicted seizure. This embodiment allows the patient to spend less time under the influence of the AED. The reduction of exposure to the AED reduces the amount of time that the patient must also experience the side effects of these drugs, as well as, extends the length of time that the patient has before his or her body begins to generate a tolerance response.

In addition to or as an alternative to the communication provided to the patient, the systems and methods of the present invention can also provide an automatic, closed-loop treatment to the patient to prevent or manage the predicted seizure. The automatic treatment can comprise electrical stimulation and/or drug delivery via an implanted or external drug dispenser. The electrical stimulation can be intracranial stimulation of a nervous system component, extracranial stimulation of a nervous system component, (e.g., a peripheral nerve, such as the vagus nerve), or a combination thereof.

In another specific aspect, the present invention provides a system that comprises a predictive algorithm that can be used to modify or alter the scheduling and dosing of a chronically prescribed pharmacological agent, such as an AED, to optimize or custom tailor the dosing to a particular patient at a particular point in time (e.g., titration). This allows for improved (1) efficacy for individual patients, since there is variation of therapeutic needs among patients, and for (2) improved response to variation in therapeutic needs for a given patient with time, resulting from normal physiological variations as well as from external and environmental influences, such as stress, sleep deprivation, the presence of flashing lights, alcohol intake, and the like The predictive algorithm can be used to characterize a patient's propensity for the future seizure, typically by monitoring and processing the patient's brain activity waves (e.g., EEG). If the predictive algorithm determines that the patient is at an increased propensity or probability of an epileptic seizure or otherwise predicts the onset of a seizure, the system can provide a warning or an output that indicates or otherwise recommends or instructs the patient to take an acute dosage of a pharmacological agent or an accelerated or increased dosage of a chronically prescribed pharmacological agent. Consequently, the present invention is able to provide a lower chronic plasma level of the therapeutic agent (e.g., an AED) and modulate the intake of the prescribed agent in order to decrease side effects, maximize benefit of the therapeutic agent, and reduce the tolerance response.

“Antiepileptic drug” (AED) will be used interchangeably with the term “anticonvulsant agent,” and as used herein, generally encompasses pharmacological agents capable of reducing the frequency or likelihood of a seizure, and/or treating, inhibiting or preventing seizure activity or ictogenesis when the agent is administered to a subject or patient. There are many drug classes that comprise the set of antiepileptic drugs (AEDs), and many different mechanisms of action are represented. For example, some medications are believed to increase the seizure threshold, thereby making the brain less likely to initiate a seizure. Other medications retard the spread of neural bursting activity and tend to prevent the propagation or spread of seizure activity. Some AEDs, such as the benzodiazepines, act via the GABA receptor and globally suppress neural activity. However, other AEDs can act by modulating a neuronal calcium channel, a neuronal potassium channel, a neuronal NMDA channel, a neuronal AMPA channel, a neuronal metabotropic type channel, a neuronal sodium channel, and/or a neuronal kainite channel.

“A subject in need of treatment with an AED” would include an individual who is known to have the disease epilepsy or has had repeated seizures or convulsions or has shown the symptoms of an analogous seizure-related disorder regardless of the etiology of these symptoms.

The terms “subject” or “patient” are used herein interchangeably and as used herein, refer to a human being, who has been the object of treatment, observation or experiment. “Subject” or “patient” also includes a human being who has not yet shown the symptoms of epilepsy or analogous seizure-related disorder but who can be in a high risk group.

“Composition” is intended to encompass a product comprising the specified ingredients in the specified amounts, as well as any product which results, directly or indirectly, from combinations of the specified ingredients in the specified amounts.

Where the compounds according to this invention have at least one chiral center, they can accordingly exist as enantiomers. Where the compounds possess two or more chiral centers, they can additionally exist as diastereomers. It is to be understood that all such isomers and mixtures thereof are encompassed within the scope of the present invention. Furthermore, some of the crystalline forms for the compounds can exist as polymorphs and as such are intended to be included in the present invention. In addition, some of the compounds can form solvates with water (i.e., hydrates) or common organic solvents, and such solvates are also intended to be encompassed within the scope of this invention.

The invention includes within its scope prodrugs of the compounds of this invention. In general, such prodrugs will be functional derivatives of the compounds that are readily convertible in vivo into the required compound. Thus, in the methods of treatment of the present invention, the term “administering” shall encompass the treatment of the various disorders described with the compositions specifically disclosed or with a composition which can not be specifically disclosed, but which converts to the specified compound in vivo after administration to the patient. Prodrugs are bioreversible derivatives of drug molecules used to overcome some barriers to the utility of the parent drug molecule. These barriers include, but are not limited to, solubility, permeability, stability, presystemic metabolism and targeting limitations (see, for example, Medicinal Chemistry: Principles and Practice, 1994, ISBN 0-85186-494-5, Ed.: F. D. King, p. 215; J. Stella, “Prodrugs as therapeutics”, Expert Opin. Ther. Patents, 14: 277-280, 2004; P. Ettcaner et al., 2004, J. Med. Chem., 47: 2393-2404). Conventional procedures for the selection and preparation of suitable prodrug derivatives are described, for example, in “Design of Prodrugs”, ed. H. Bundgaard, Elsevier, 1985.

The present invention also extends to formulations which are bioequivalent to the tablets or formulations of the present invention, in terms of both rate and extent of absorption, for example as defined by the US Food and Drug Administration and discussed in the so-called “Orange Book” (Approved Drug Products with Therapeutic Equivalence Evaluations, U.S. Dept of Health and Human Services, 26th edition, 2006).

It is to be understood that this invention is not limited to particular methods, reagents, compounds, compositions, or biological systems, which can, of course, vary. It is also to be understood that the terminology used herein is for the purpose of describing particular aspects only, and is not intended to be limiting. As used in this specification and the appended claims, the singular forms “a”, “an”, and “the” include plural referents unless the content clearly dictates otherwise. Thus, for example, reference to “an antiepileptic drug” can include a combination of two or more antiepileptic drugs, and the like.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein. In describing and claiming the present invention, the following terminology will be used.

“Treating” or “treatment” includes the administration of the compositions, compounds or agents of the present invention to prevent or delay the onset of the symptoms, complications, or biochemical indicia of a disease, alleviating or ameliorating the symptoms or arresting or inhibiting further development of the disease, condition, or disorder (e.g., epilepsy and epilepsy-related disorders). “Treating” further refers to any indicia of success in the treatment or amelioration or prevention of the disease, condition, or disorder (e.g., epilepsy and epilepsy-related disorders), including any objective or subjective parameter such as abatement; remission; diminishing of symptoms or making the disease condition more tolerable to the patient; slowing in the rate of degeneration or decline; or making the final point of degeneration less debilitating. The treatment or amelioration of symptoms can be based on objective or subjective parameters; including the results of an examination by a physician. Accordingly, the term “treating” includes the administration of the compounds or agents of the present invention to prevent or delay, to alleviate, or to arrest or inhibit development of the symptoms or conditions associated with epilepsy or epilepsy-related diseases or disorders. The term “therapeutic effect” refers to the reduction, elimination, or prevention of the disease or disorder, symptoms of the disease or disorder, or side effects of the disease or disorder in the subject. “Treating” or “treatment” using the methods of the present invention includes preventing the onset of symptoms in a subject that can be at increased risk of an epilepsy or epilepsy-related diseases or disorders, inhibiting the symptoms of epilepsy or epilepsy-related diseases or disorders (slowing or arresting its development), providing relief from the symptoms or side-effects of epilepsy and epilepsy-related disorders (including palliative treatment), and relieving the symptoms of epilepsy and epilepsy-related disorders (causing regression). Treatment can be prophylactic (to prevent or delay the onset of the disease, or to prevent the manifestation of clinical or subclinical symptoms thereof) or therapeutic suppression or alleviation of symptoms after the manifestation of the disease or condition.

The terms “treatment”, “treating”, and the like are therefore used herein to refer to any treatment of epilepsy or epilepsy-related disease or disorder in a mammal, e.g., particularly a human being, and includes: a) preventing a disease, condition, or symptom of a disease that causes epilepsy, or undergoing a medical treatment that causes epilepsy, or suffering from an injury that causes epilepsy to occur in a subject which can be predisposed to the disease but has not yet been diagnosed as having it and/or that causes epilepsy or epilepsy-related disorders, or suffering from an injury that causes epilepsy, or undergoing a medical treatment that causes epilepsy; b) inhibiting a disease, condition, or symptom of epilepsy, or undergoing a medical treatment that causes epilepsy, or suffering from an injury that causes epilepsy to occur in a subject which can be predisposed to the disease but has not yet been diagnosed as having it and/or that causes an epilepsy, or suffering from an injury that causes epilepsy, or undergoing a medical treatment that causes epilepsy (e.g., arresting its development and/or delaying its onset or manifestation in the patient; and/or c) relieving a disease, condition, or symptom of a disease or condition that causes epilepsy, or undergoing a medical treatment that causes epilepsy, or suffering from an injury that causes epilepsy to occur in a subject which can be predisposed to the disease but has not yet been diagnosed as having it and/or that causes epilepsy, or suffering from an injury that causes epilepsy, or undergoing a medical treatment that causes epilepsy, e.g., causing regression of the condition or disease and/or its symptoms.

A “chronic disease” or “condition” is a disease or condition that is long-lasting or recurrent. The term chronic describes the course of the disease, or its rate of onset and development. A chronic course is distinguished from a recurrent course; recurrent diseases or conditions relapse repeatedly, with periods of remission in between. Treatment of recurrent diseases and conditions with a therapeutic agent or agents disclosed herein are also contemplated. A chronic disease or condition can have one or more of the following characteristics: a chronic disease or condition is permanent, leaves residual disability, can be caused by nonreversible pathological alteration, requires special training of the patient for rehabilitation, or can be expected to require a long period of supervision, observation, or care. Thus, the term “treatment” or “to treat” is intended to include any action that improves, prevents, reverses, arrests, or inhibits the pathological process of epilepsy or epilepsy related diseases and disorders, as that term is defined and used herein. The treatment or amelioration of symptoms can be based on objective or subjective parameters; including the results of a physical examination, neurological examination, and/or psychiatric evaluation. The term “treating” or “treatment” includes the administration of the therapeutic agents or compounds of the present invention to treat, prevent, reverse, arrest, or inhibit the process of epilepsy or epilepsy related diseases and disorders. In some instances, treatment with the compounds of the present invention will prevent, inhibit, or arrest the progression of brain dysfunction or brain hyperexcitability associated with epilepsy.

“Concomitant administration” of a known drug or agent with a therapeutic agent of the present invention (such as an AED) means administration of the drug and therapeutic agent at such time that both the known drug and the compound will have a therapeutic effect or diagnostic effect. Such concomitant administration can involve concurrent (i.e., at the same time), prior, or subsequent administration of the drug with respect to the administration of the therapeutic agent of the present invention. A person of ordinary skill in the art would have no difficulty determining the appropriate timing, sequence and dosages of administration for particular drugs and therapeutic agents of the present invention.

The term “ictal” is used to refer to a neurological state or condition associated with a seizure.

The term “pre-ictal” is used to refer to a neurological state or condition that immediately precedes a seizure.

The term “pro-ictal” is used herein to refer to a neurological state or condition characterized by an increased likelihood of transition to an ictal state. A pro-ictal state may transition to either an ictal or inter-ictal state. A pro-ictal state that transitions to an ictal state is also referred to as pre-ictal.

The term contra-ictal is used to refer to a neurological state or condition that shows an absence of seizure or a safe condition.

The term inter-ictal is used to refer to a neurological state or condition that is considered normal.

The term post-ictal is used to refer to a neurological state or condition that occurs after a seizure.

B. Exemplary Indications, Conditions, Diseases and Disorders

While the following discussion focuses therapies for managing epilepsy, the present invention can also be applicable to controlling or managing other neurological or non-neurological disorders with a predictive system and the administration of other acute pharmacological agents or other acute treatments. For example, the present invention can also be applicable to management of Parkinson's disease, essential tremor, Alzheimer's disease, migraine headaches, depression, sleep apnea and other sleep disorders, eating disorders, bipolar disorders, or the like. As can be appreciated, the features extracted from the signals and used by the predictive system will be specific to the underlying disorder that is being managed. While certain features can be relevant to epilepsy, such features may or may not be relevant to the state measurement for other disorders.

As used herein, unless otherwise noted, the terms “epilepsy and related disorders” or “epilepsy or related disorder” shall mean any disorder in which a subject (preferably a human adult, child or infant) experiences more than one seizure. Suitable examples include, but are not limited to, epilepsy (including, but not limited to, localization-related epilepsies, generalized epilepsies, epilepsies, epilepsies with both generalized and local seizures, and the like), seizures as a complication of a disease or condition (such as seizures associated with encephalopathy, phenylketonuria, juvenile Gaucher's disease, Lundborg's progressive myoclonic epilepsy, stroke, head trauma, stress, hormonal changes, drug use or withdrawal, alcohol use or withdrawal, sleep deprivation, and the like), and the like.

Epilepsy also embraces (1) focal epilepsies including benign occipital epilepsy, benign rolandic epilepsy, frontal lobe epilepsy, occipital lobe epilepsy, medial temporal lobe epilepsy and parietal lobe epilepsy; (2) generalized idiopathic epilepsies including benign myoclonic epilepsy in infants, juvenile myoclonic epilepsy, childhood absence epilepsy, juvenile absence epilepsy and epilepsy with generalized tonic clonic seizures in childhood; (3) generalized symptomatic epilepsies including infantile spasm (West syndrome), Lennox-Gastaut syndrome and progressive myoclonus epilepsies, and; (4) unclassified epilepsies including refractory epilepsy, post-stroke epilepsy, febrile fits, epilepsy with continuous spike and waves in slow wave sleep, Landau Kleffner syndrome, Rasmussen's syndrome and epilepsy and inborn errors of metabolism.

C. Tolerance

Tolerance can be defined as the reduction in response to a drug after repeated administrations. The following classifications of tolerance responses were described in the overview in Loscher, W. and D. Schmidt, 2006, Epilepsia 47(8): 1253-1284. More comments on this subject are found in a Critical Commentary by G. Avanzini (Avanzini, G., 2006, Epilepsia 47(8): 1285-1287). Further information about the drugs used in the treatment of seizures was found in the overviews “Antiepileptic Drugs: An Overview”, written by Juan G. Ochoa, M.D. and Willise Riche, M.D. (2006) published as a web article: http://www.emedicine.com/neuro/topic692.html and “Newer Antiepileptic Drugs: Gabapentin, Lamotrigine, Felbamate, Topiramate and Fosphenyloin”, by William J. Curry, M.D. and David L. Kulling, M.D. (1998) published as a web article: http://www.aafp.org/afp/980201ap/curry.html. These changes in responsiveness can lead to challenges that can impact patients financially and medically. In order to counteract the tolerance response, patients can require a dosing strategy that increases the amount of drug taken or the frequency with which it is taken. The tolerance response forces physicians to try alternative treatment strategies. This response can occur quickly or over time. Occasionally there is a preexisting insensitivity to a drug which is called innate tolerance. The tolerance that is the subject of this invention is called acquired. Acquired tolerance can be divided into three types: pharmacokinetic, pharmacodynamic, and learned tolerance.

Pharmacokinetic Tolerance

Pharmacokinetic tolerance reflects the changes that the body makes in its metabolism of the drug. The body response to the drug affects its efficacy at the site of action. The body can increase its metabolism of a drug such that the patient continuously has to consume more of the drug to achieve the same effect. Many of the earlier drugs used to combat epilepsy cause the body to create increasing amounts of hepatic microsomal enzymes. These higher levels of enzymes increase the rate at which the drugs are metabolized and can oftentimes increase the rate at which other drugs are metabolized as well. This tolerance response requires that the dosing be increased to overcome the effect of the hepatic enzyme.

Pharmacodynamic Tolerance

This type of tolerance comes from the changes in the body that have taken place to adapt to the drug. These changes can result in lower receptor density or weaker receptor coupling to signal-transduction pathways.

Learned Tolerance

This type of tolerance is also called behavioral tolerance. These are the behavioral and psychological adaptations that a person makes to function in a state of inebriation. This can include the reduction of adverse effects on the long term administration of these kinds of drugs.

Conditioned Tolerance

This type of learned or behavioral tolerance is a response to cues that are specific to an event or an environment. Also called situation specific tolerance, this response occurs over time as the patient is becomes accustomed to the sights, smells or situations that are encountered at that time of the drug delivery. When a drug affects a body by creating a sense of sedation and changes normal metabolic functions like pulse rate, the body attempts to counteract these effects and maintain a standard of normalcy. If a patient takes a drug in the same way or place, this induces the body to anticipate the delivery of the drug and begins its counteracting mechanisms. Things such as the smell of the drug preparation, sight of a syringe, or specific room conditions like light our temperature can induce a response in the body that is designed to counteract the effects of the drug. This response is Pavlovian in nature and can be avoided by receiving the drug in new or unexpected ways. This type of tolerance can also be avoided if there is a means for reducing the regularity of dosing or enabling the patient to receive the doses in different environments or delivering the drug without the patient being aware of the dosing (e.g., implanted drug pump).

Contingent Tolerance

This type of tolerance is contingent on the when a stimulating experience occurs and whether or not it occurs in the presence of the antiepileptic drug. Studies have shown that some antiepileptic drugs lose their anticonvulsant efficacy when convulsive activity occurs in the presence of these drugs.

Acute Tolerance

This term refers to a rapid tolerance response. The response can occur even with the first dosage of an antiepileptic drug. Rapid tolerance is sometimes differentiated from acute tolerance in that rapid tolerance is seen in response to a second dose of the drug given 8-24 hours after the effect of the first dose has worn off. As single dose of one drug can produce tolerance to the next dose. Acute tolerance develops during rapidly repeating injections, also known as, tachyphylaxis. This term describes the loss of efficacy of sympthomimetic drugs like ephedrine because of a lower response from some nerve endings. The most common form of tolerance is the type that develops over time and remains constant after several weeks of exposure.

Cross Tolerance

As discussed above, this type of tolerance occurs when a body becomes tolerant to an entire class of drugs. It is not the same as drug-drug interaction but is the result of developing a tolerance to a similar drug and having the body recognize a new drug as the one it has grown tolerant to.

Epilepsy threatens not only the health and safety of those that suffer from the disease but also compromises the quality of life for them as well. As these patients experience a wide spectrum of symptoms ranging from the slightest of tremors to full blown status epilepticus, their universal complaint is the lurking risk of impending seizures that may compromise their health and safety. To further complicate matters, these patients are often at odds with their own bodies' responses to the pharmaceutical remedies that offer relief from the hazards that these seizures present. The range of tolerance responses to these drugs creates a slippery slope for these patients and exacerbates the formulation of a lasting and consistent treatment profile.

Furthermore, the pharmaceutical compounds that are used to treat these seizures very often affect the basic functions of the central nervous system itself and carry with them their own hazards as they can prevent or delay the wave of electrical discharge that travels the length of the cell membrane. Not only do patients who suffer from seizures live with the anticipation of an impending seizure but they also must try to function in their daily lives under the influence of drugs that inhibit the body's internal system of communication.

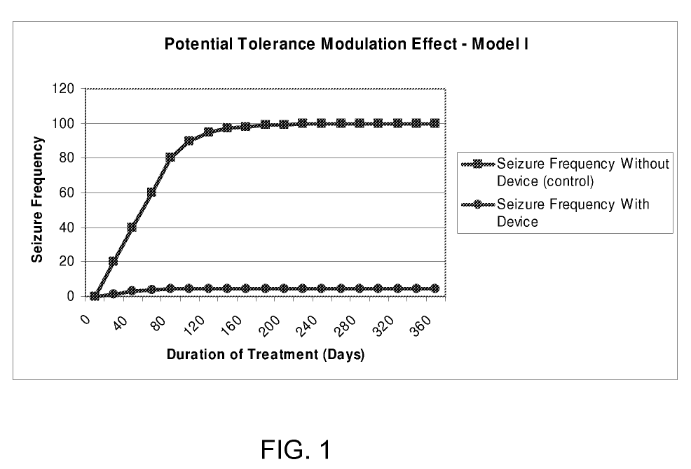

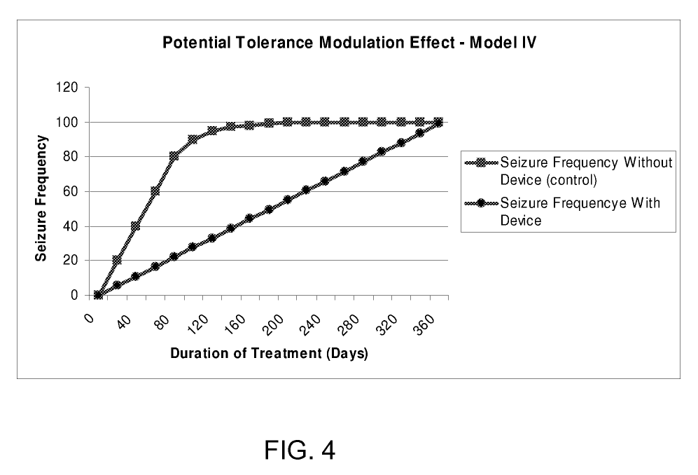

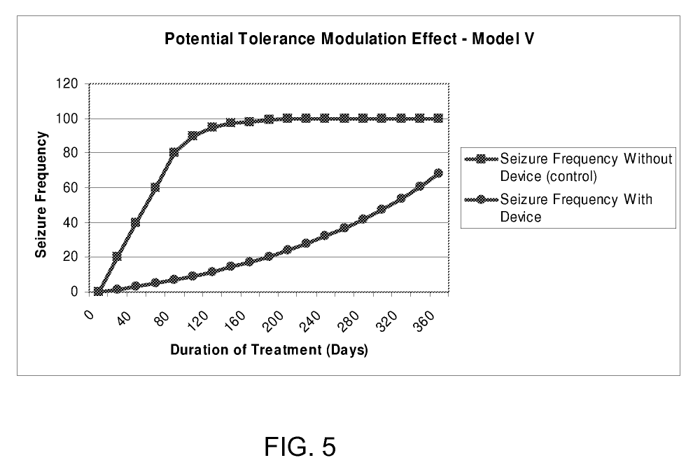

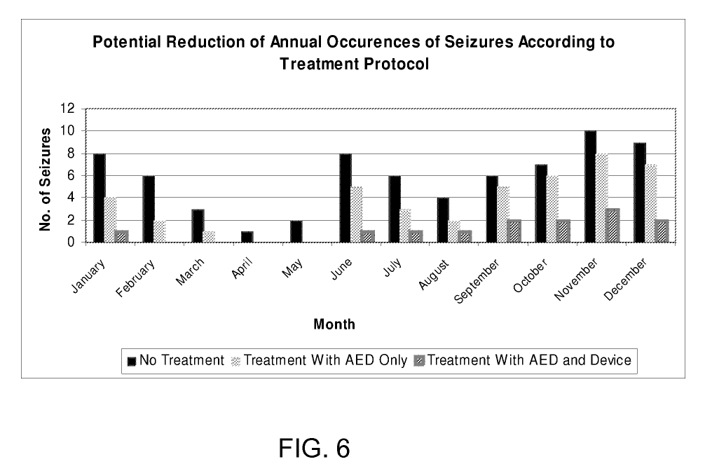

FIGS. 1-5 present some potential tolerance responses to an AED when used in conjunction with the current invention compared to the tolerance response to an AED in the absence of the current invention (control). The x-axis represents time (duration of treatment) in number of days. The y-axis represents the number of potential seizures experienced by a patient undergoing no pharmaceutical or mechanical intervention normalized to 1 (i.e. 100%). Seizure frequency is defined as the number of seizures experienced by a patient during a given period of time. The curve which displays each data point as a square represents the potential number of seizures a patient might experience if only treated with a pharmacological regimen. This is the control curve. The curve which displays each data point as a circle represents the potential number of seizures a patient might experience if treated with both a pharmacological and a mechanical regimen. FIG. 6 represents the potential number of annual occurrences of seizures according to the various treatment protocols: no treatment, treatment with AED only and treatment with AED and current invention.

The first potential tolerance response (FIG. 1) to an AED when used in conjunction with the current invention is one where the seizure frequency is drastically reduced and the effectiveness of the AED remains as almost as potent in the body of the patient on the last day of use as it was on the first day of use. This potential response would exhibit maximum effectiveness of the device in preventing the tolerance response to an AED compared to the control.

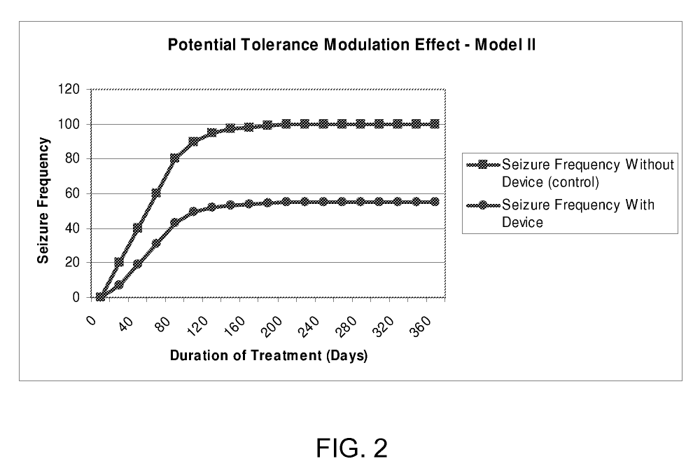

Another potential tolerance response is one that mimics the seizure frequency curve of the control but reaches an upper limit of tolerance that is below the upper limit of the control (FIG. 2). This asymptotic leveling of seizure frequency implies that a tolerance response to the AED does occur but levels off and never approaches the limits of the control response and improves the long term efficacy of the AED.

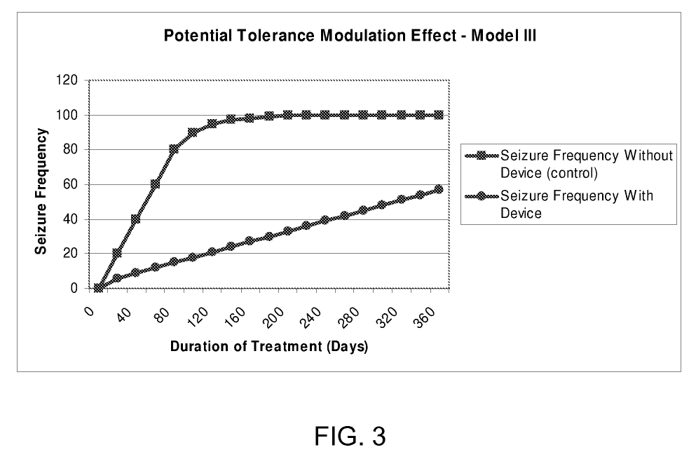

Further potential responses involve device assisted tolerance responses that slowly approach that of the control response—seizure frequency may reach the control levels while others may never reach the level of the control response. Although the seizure frequency may eventually approach control levels, the device assisted response takes longer to arrive at that level—and potentially on a less steep curve—and hence lengthens the time period of efficacy of the AED. These potential responses are depicted in FIGS. 3-5.

FIG. 6 shows the potential advantage of including the disclosed device in a treatment regimen for seizures. FIG. 6 shows a hypothetical data comparison of the number of seizures a patient could have without AED intervention to the potentially reduced number of seizures that a patient could experience with the use of one or more AEDs to the potentially further reduced number of seizures that a patient may experience when using one or more AEDs with the disclosed device. Patients on a conventional regimen of AEDs typically develop a tolerance response some time period after taking the AEDs. While a patient using the present invention may also eventually develop a tolerance response, it is contemplated that the systems of the present invention will reduce or prevent the tolerance response and increase the efficacy of the AED for the patient.

The methods and systems described herein improve the efficacy of existing therapeutic agents by replacing high chronic dosages of the therapeutic agents with acute dosages or titrated chronic dosages that are related to their risk of a seizure, thus reducing the various tolerance effects that are currently associated with many of the therapeutic agents described herein. Below is an overview of exemplary therapeutic agents that are used, or have been used, to treat epilepsy and seizures. These drugs range widely in effectiveness, as well as, potential side effects. Whether the drug is a simple salt like potassium bromide or a classic barbiturate, all have some limitation in effectiveness which can be further limited by the tolerance response of the body. The present invention enables the use of acute dosage of drugs and the reduced dosage of types of drugs that may have been discontinued due to high tolerance effects or other intolerable side effects.

D. Exemplary Therapeutic Agents

Some of the antiepileptic drugs, AEDs, that can be used with the present invention will now be described. Antiepileptic or anticonvulsant drugs may suppress the rapid and excessive firing of neurons that start a seizure. They may interrupt the action potential of a cell, which is a wave of electrical discharge that travels along the membrane of a cell. Anticonvulsant drugs are classified by their mechanism of action. These groups include but are not limited to sodium channel blockers, calcium current inhibitors, gamma-aminobutyric acid (GABA) enhancers, glutamate blockers, carbonic anhydrase inhibitors, hormones, and drugs with unknown mechanisms of action. These drugs work to inhibit rather than excite the processes that lead to the development of a seizure.

Antiepileptic drugs function by at least one of several mechanisms to control neural firing activity. The major classes based on the mechanism of action are as follows:
1) Modulation of voltage dependent ion channels
   a) Sodium channel blockade
   b) Calcium channel blockade
   c) Potassium channel facilitation
2) Enhancement of Synaptic Inhibition
   a) GABA Agonists
      i) Benzodiazepines
      ii) Barbiturates
      iii) Felbamate
      iv) Topiramate
   b) Glycine
   c) Regionally Specific Transmitter Systems
      i) Monoamines
         (1) Catecholamines
         (2) Serotonin
         (3) Histamine
      ii) Neuropeptides
         (1) Opioid Peptides
         (2) Neuropeptide Y
      iii) Inhibitory Neuromodulator
         (1) Adenosine
3) Inhibition of synaptic transmission
   a) NMDA Antagonists
   b) AMPA Antagonists
   c) Metabotropic Type
   d) Kainate Type
4) It can also be said that an antiepileptic drug is:
   a compound that modulates the sodium channels of a cell;
   a compound that modulates the sodium currents of a cell;
   a compound that modulates the calcium channels of a cell;
   a compound that modulates the calcium currents of a cell;
   a compound that modulates the potassium channels of a cell;
   a compound that modulates the potassium currents of a cell;
   a compound that modulates glutamic acid decarboxylase;
   a compound that binds to a gamma-aminobutyric acid receptor site;
   a compound that inhibits the metabolism of gamma-aminobutyric acid;
   a compound that inhibits the reuptake of gamma-aminobutyric acid;
   a compound that binds to a glutamate binding site;
   a compound that binds to an alpha-amino-3-hydroxy-5-methylisoxazole-4-propionic acid (AMPA) binding site;
   a compound that binds to a kainate binding site;
   a compound that binds to an N-methyl-D-aspartate (NMDA) binding site;
   a compound that binds to a glycine binding site;
   a compound that binds to a metabotropic binding site;
   a compound that is a natural or synthetic hormone;
   a compound that inhibits carbonic anhydrase; or
   a combination thereof.
5) The list of pharmacological agents that can be used to treat epilepsy include but is not limited to: barbiturates, hydantoins, oxazolidinediones, succinimides, benzodiazepines, carboxamides, fatty acid derivatives, fructose derivatives, carboxylic acid, GABA analogs, monosaccharides, aromatic allylic alcohols, ureas, triazines, phenyltriazines, carbamates, pyrrolidines, pyrimidinediones, sulfonamides, valproic acids, valproates, valproylamides, propionates, aldehydes, bromides or a combination thereof
6) A list of potential antiepileptic drugs includes but is not limited to: Barbexaclone, Metharbital, Methylphenobarbital, Phenobarbital, Primidone, Ethotoin, Fosphenyloin, Mephenyloin, Phenyloin, Ethadione, Paramethadione, Trimethadione, Ethosuximide, Mesuximide, Phensuximide, Clobazam, Clonazepam, Clorazepate, Diazepam, Lorazepam, Midazolam, Nitrazepam, Temazepam, Carbamazepine, Oxcarbazepine, Rufinamide, Valpromide, Valnoctamide, Valproic acid, Sodium Valproate, Valproate Semisodium, Tiagabine, Gabapentin, Pregabalin, Progabide, Vigabatrin, Topiramate, Stiripentol, Phenacemide, Pheneturide, Lamotrigine, Emylcamate, Felbamate, Meprobamate, Brivaracetam, Levetiracetam, Nefiracetam, Seletracetam, Acetazolamide, Ethoxzolamide, Sultiame, Methazolamide, Zonisamide, Beclamide, Paraldehyde, Potassium Bromide, Divalproex Sodium, Ganaxolone, Huperzine A, JZP-4, Lacosamide (SPM 927), NS1209, Retigabine, RWJ 333369, Talampanel, Eslicarbazepine acetate, Fluorofelbamate, Propylisopropyl acetamide, Valrocemide or a combination thereof.

The structure of the active ingredients identified by code nos., generic or trade names can be taken from the actual edition of the standard compendium “The Merck Index” or from databases, e.g. Patents International (e.g. IMS World Publications). The corresponding content thereof is hereby incorporated by reference. Any person skilled in the art is fully enabled to identify the active ingredients and, based on these references, likewise enabled to manufacture and test the pharmaceutical indications and properties in standard test models, both in vitro and in vivo. Some specific examples of antiepileptic drugs that can be used with the present invention are described below:

Hydantoins:

Phenyloin (Diphenylhydantoin, Dilantin, Diphenylan) is used typically for all types of partial and tonic-clonic seizures. Other suitable hydantoins include mephenyloin, ethotoin and fosphenyloin.

Phenyloin has the following structure:

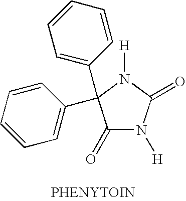

A 5-phenyl or other aromatic substituent appears important for activity. Chronic control of seizures is generally obtained with concentrations above 10 μg/ml, while toxic effects such as nystagmus develop at concentrations around 20 μg/ml.

Anti-Seizure Barbiturates:

Phenobarbital, N-methylphenobarbital, and metharbital are typically used in therapies for epilepsy. Other barbituates can also be used in the present invention, such as pentobarbital, barbexaclone, metharbital and methylphenobarbital. N-methylphenobarbital (Mephobarbital; Mebaral) and phenobarbital are effective agents for generalized tonic-clonic and partial seizures.

During long term therapy in adults, the plasma concentration of phenobarbital averages about 10 μg/ml per daily dose of 1 mg/kg; in children the value is between about 5 to about 7 μg/ml per 1 mg/kg. Plasma concentrations of about 10 to about 35 μg/ml are recommended for control of seizures; about 15 μg/ml is generally the minimum for prophylaxis against febrile convulsions.

Deoxybarbiturates:

Primidone (mysoline) is used against partial and tonic-clonic seizures. During long term therapy, plasma concentrations of primidone and phenobarbital average between about 1 μg/ml and about 2 μg/ml, respectively, per daily dose of 1 mg/kg of primidone.

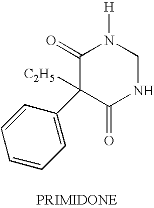

Iminostilbenes or Carboxamides:

Carbamazepine is used in the treatment of partial and tonic-clonic seizures. The term “carboxamides” as used herein includes, but is not limited to carbamazepine, oxcarbazepine, 10-hydroxy-10,11-dihydrocarbamazepine and the compounds of formula

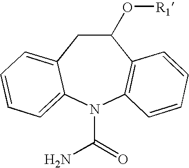

wherein R₁′ represents C₁-C₃alkyl carbonyl.

Carbamazepine is a derivative of iminostilbene with a carbamyl group at the 5 position. Therapeutic concentrations are between about 6 to about 12 μg/ml. Oxcarbazepine (Trileptal) is a keto analog of carbamazepine which acts as a prodrug in humans. Oxcarbazepine is typically used as a monotherapy or adjunct therapy for partial seizures in adults and as adjunctive therapy for partial seizures in children. Oxcarbazepine is thought to block voltage-sensitive sodium channels. In addition, increases potassium conductance and modulation of high-voltage activated calcium channels, which can also have a role in controlling seizures. Dosage is between about 0.6 to about 2.4 g/day.

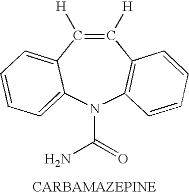

Succinimides:

Ethosuximide (Zarontin) is typically used for the treatment of absence seizures. Methsuximide (Celontin) and phensuximide (Milontin) have phenyl substituents and are more active against maximal electroshock seizures. During long-term therapy, the plasma concentration of ethosuximide averages between about 2 μg/ml per daily dose of 1 mg/kg. A plasma concentration of between about 40 to about 400 μg/ml is required for satisfactory control of absence seizures in most patients. An initial daily dose of 250 mg in children and 500 mg in older children and adults is increased by 250 mg increments at weekly intervals until seizures are adequately controlled or toxicity intervenes. Divided dosage is required occasionally to prevent nausea or drowsiness associated with single daily dosage. The usual maintenance dose is about 20 mg/kg per day.

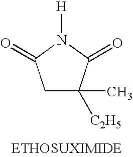

Valproic Acid:

Valproic acid (n-dipropylacetic acid) is a simple branched-chain carboxylic acid. The concentration of valproate in plasma that is associated with therapeutic effects is between about 30 to about 100 μg/ml. Valproate is effective in the treatment of absence, myoclonic, partial, and tonic-clonic seizures. The initial daily dose is usually about 15 mg/kg, and this is increased at weekly intervals by between about 5 to about 10 mg/kg per day to a maximum daily dose of 6 mg/kg. Divided doses are given when the daily dose exceeds 250 mg. Other suitable compounds in this class are tiagabine and valproate semi-sodium. valproic acid sodium salt, tiagabine hydrochloride monohydrate and vigrabatrine.

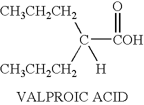

Benzodiazepines:

A large number of benzodiazepines have broad anti-seizure properties. In the United States, clonazepam (Klonopin) and clorazepate (Traxene-SD, others) have been approved for chronic, long term treatment of seizures. Diazepam (Valium, Diastat, others) and lorazepam (Ativa) are commonly used in the management of status epilepticus.

Clonazepam is useful in the therapy of absence seizures as well as myoclonic seizures in children. The initial dose of clonazepam for adults does not typically exceed 1.5 mg per day, and for children is between about 0.01 to about 0.03 mg/kg per day. The dose-dependent side effects are reduced if two or three divided doses are given each day. The dose can be increased every 3 days in amounts of between about 0.25 to about 0.5 mg per day in children and between about 0.5 to about 1 mg per day in adults. The maximal recommended does is 20 mg per day for adults and 0.2 mg/kg per day for children.

While diazepam is an effective agent for treatment of status epilepticus, its short duration of action is a disadvantage, leading to the use of intravenous phenyloin in combination with diazepam. Diazepam is administered intravenously and at a rate of no more than about 5 mg per minute. The usual dose for adults is between about 5 to about 10 mg as required; this can be repeated at intervals of 10 to 15 minutes, up to a maximal dose of about 30 mg. If necessary, this regime can be repeated in 2 to 4 hours, but no than 100 mg should be administered in a 24-hour period.

Clorazepate is effective in combination with certain other drugs in the treatment of partial seizures. The maximum initial dose of clorazepate is 22.5 mg per day in three portions for adults and 15 mg per day in two doses in children. Other benzodiazepines are Clobazam, Nitrazepam, Temazepam and Midazolam.

Gabapentin:

Gabapentin (Neurontin) is typically used in the treatment of partial seizures, with and without secondary generalization, in adults when used in addition to other anti-seizure drugs. Gabapentin is usually effective in doses of between about 900 to about 1800 mg daily in three doses. Therapy is usually begun with a low dose (300 mg once on the first day), and the dose is increased in daily increments of 300 mg until an effective dose is reached. Gabapentin is structurally related to the neurotransmitter, GABA. Other compounds that are similar to gabapentin are Pregabalin, Progabide, and Vigabatrin.

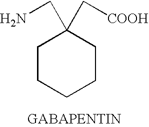

Lamotripine:

Lamotrigine (Lamictal) is a phenyltriazine derivative. It is used for monotherapy and add-on therapy of partial and secondarily generalized tonic-clonic seizures in adults and Lennox-Gastaut syndrome in both children and adults. Patients who are already taking a hepatic enzyme-inducing anti-seizure drug are typically given lamotrigine initially at about 50 mg per day for 2 weeks. The dose is increased to about 50 mg twice per day for 2 weeks and then increased in increments of about 100 mg/day each week up to a maintenance dose of between about 300 to about 500 mg/day in two divided doses. For patients taking valproate in addition to an enzyme-inducing anti-seizure drug, the initial dose is typically about 25 mg every other day for 2 weeks, followed by an increase to 25 mg/day for two weeks; the dose then can be increased to 50 mg/day every 1 to 2 weeks up to a maintenance dose of about 100 to about 150 mg/day divided into two doses. Lamotrigine is a use-dependent blocker of voltage-gated sodium channels and inhibitor of glutamate release.

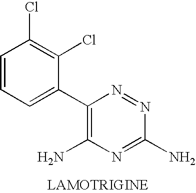

Levetiracetam:

Levetiracetam (Keppra) is a pyrrolidine, the racemically pure S-enantiomer of α-ethyl-2-oxo-1-pyrrolidineacetamide, and is typically used for treating partial seizures. Dosage is about 3 gm/day. Other compounds that are similar to livetiracetam are Nefiracetam, Selectractam, and Brivaracetam.

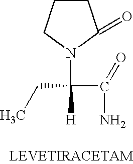

Tiagabine:

Tiagabine inhibits the uptake of the neurotransmitter GABA, which results in an increase in GABA-mediated inhibition with in the brain. The dosage with enzyme-inducing drugs is between about 30 to about 45 mg/day and without enzyme-inducing drugs is between about 15 to about 30 mg/day.

Topiramate:

Topiramate is a sulphamate-substituted monosaccharide. Its mode of action probably involves the following: blockade of voltage-sensitive sodium channels; enhancement of GABA activity; antagonism of certain subtypes of glutamate receptors; and inhibition of some isozymes of carbonic anhydrase. The dosage is between about 200 to about 400 mg/day, with a maximum of about 800 mg/day.

Zonisamide:

ZONEGRAN™ (zonisamide) is an anti-seizure drug chemically classified as a sulfonamide. The active ingredient is zonisamide, 1,2-benzisoxazole-3-methanesulfonamide. ZONEGRAN is supplied for oral administration as capsules containing 100 mg zonisamide.

Zonisamide can produce these effects through action at sodium and calcium channels. In vitro pharmacological studies suggest that zonisamide blocks sodium channels and reduces voltage-dependent, transient inward currents (T-type Ca²⁺ currents), consequently stabilizing neuronal membranes and suppressing neuronal hypersynchronization. In vitro binding studies have demonstrated that zonisamide binds to the GABA/benzodiazepine receptor ionophore complex in an allosteric fashion which does not produce changes in chloride flux. Other in vitro studies have demonstrated that zonisamide (10-30 μg/mL) suppresses synaptically-driven electrical activity without affecting postsynaptic GABA or glutamate responses (cultured mouse spinal cord neurons) or neuronal or glial uptake of [3H]-GABA (rat hippocampal slices). Thus, zonisamide does not appear to potentiate the synaptic activity of GABA. In vivo microdialysis studies demonstrated that zonisamide facilitates both dopaminergic and serotonergic neurotransmission. Zonisamide also has weak carbonic anhydrase inhibiting activity, but this pharmacologic effect is not thought to be a major contributing factor in the antiseizure activity of zonisamide. Other compounds similar to Zonisamide are Acetazolamide, Ethoxzoloamide and Sultiame.

ZONEGRAN (zonisamide) is recommended as adjunctive therapy for the treatment of partial seizures in adults. ZONEGRAN is administered once or twice daily, except for the daily dose of 100 mg at the initiation of therapy. ZONEGRAN is given orally and can be taken with or without food. The initial dose is 100 mg daily. After two weeks, the dose can be increased to 200 mg/day for at least two weeks. It can be increased to 300 mg/day and 400 mg/day, with the dose stable for at least two weeks to achieve steady state at each level. Evidence from controlled trials suggests that ZONEGRAN doses of 100-600 mg/day are effective.

Vigabatrin:

Vigabatrin is an irreversible inhibitor of gamma-aminobutyric acid transaminase (GABA-T), the enzyme responsible for the catabolism of the inhibitory neurotransmitter gamma-aminobutyric acid (GABA) in the brain. The mechanism of action of vigabatrin is attributed to irreversible enzyme inhibition of GABA-T, and consequent increased levels of the inhibitory neurotransmitter, GABA. The dosage is between about 2 to about 3 g/day, with a maximum of about 3 g/day.

The recommended starting dose is 1 g/day, although patients with severe seizure manifestations can require a starting dose of up to 2 g/day. The daily dose can be increased or decreased in increments of 0.5 g depending on clinical response and tolerability. The optimal dose range is between about 2 to about 4 g/day. Increasing the dose beyond 4 g/day does not usually result in improved efficacy and can increase the occurrence of adverse reactions. The recommended starting dose in children is 40 mg/kg/day, increasing to about 80 to about 100 mg/kg/day, depending on response. Therapy can be started at about 0.5 g/day, and raised by increments of about 0.5 g/day weekly, depending on clinical response and tolerability.

Other AEDs include Oxazolidinedione, Fatty acid derivative, Fructose derivatives, Aromatic allylic alcohols, Urea, Triazine, Phenyltriazine, Carbamate, Pyrimidinedione, Valproate, Valproylamide, Propionate, Aldehyde; and Bromide.

E. Pharmacokinetics

The following is an overview of the pharmacokinetic data for some common antiepileptic drugs.

Phenobarbital, can be administered, e.g., in the form as marketed, e.g. under the trademark Luminal™. Primidon can be administered, e.g., in the form as marketed, e.g. under the trademark Mylepsinum™. Clonazepam can be administered, e.g., in the form as marketed, e.g. under the trademark Antelepsin™. Diazepam can be administered, e.g., in the form as marketed, e.g. under the trademark Diazepam Desitin™. Lorazepam can be administered, e.g., in the form as marketed, e.g. under the trademark Tavor™. Carbamazepine can be administered, e.g., in the form as marketed, e.g. under the trademark Tegretal™. or Tegretol™. Oxcarbazepine can be administered, e.g., in the form as marketed, e.g. under the trademark Trileptal™. Oxcarbazepine is well known from the literature [see for example Schuetz H. et al., Xenobiotica (GB), 16(8), 769-778 (1986)]. The preparation of the compound of formula II wherein R₁′ is C₁-C₃alkyl carbonyl and its pharmaceutically acceptable salts is described, e.g., in U.S. Pat. No. 5,753,646. 10-Hydroxy-10,11-dihydrocarbamazepine can be prepared as disclosed in U.S. Pat. No. 3,637,661. 10-Hydroxy-10,11-dihydrocarbamazepine can be administered, e.g., in the form as described in U.S. Pat. No. 6,316,417. Phenyloin can be administered, e.g., in the form as marketed, e.g. under the trademark Epanutin™. Ethosuximide can be administered, e.g., In the form as marketed, e.g. under the trademark Suxinutin™. Mesuximide can be administered, e.g., in the form as marketed, e.g. under the trademark Petinutin™. Valproic acid sodium salt can be administered, e.g., in the form as marketed, e.g. under the trademark Leptilan™. Tiagabine hydrochloride monohydrate can be administered, e.g., in the form as marketed, e.g. under the trademark Gabitril™. Vigabatrine can be administered, e.g., in the form as marketed, e.g. under the trademark Sabril™. Levetiracetam can be administered, e.g., in the form as marketed, e.g. under the trademark Keppra™. Lamotrigine can be administered, e.g., in the form as marketed, e.g. under the trademark Lamictal™. Gabapentin can be administered, e.g., in the form as marketed, e.g. under the trademark Neurontin™. Sultiam can be administered, e.g., in the form as marketed, e.g. under the trademark Ospolot™. Felbamate can be administered, e.g., in the form as marketed, e.g. under the trademark Taloxa™. Topiramate can be administered, e.g., in the form as marketed, e.g. under the trademark Topamax™. The 1,2,3-1H-triazoles disclosed in EP 114 347 can be administered, e.g., in the form as described in U.S. Pat. No. 6,455,556. The 2-aryl-8-oxodihydropurines disclosed in WO99/28320 can be administered, e.g., in the form as described in WO99/28320. The compounds of formula I as well as their production process and pharmaceutical compositions thereof are known e.g. from WO 98/17672.

The term “AMPA antagonists” as used herein includes, but is not limited to the quinoxalinedione aminoalkylphosphonates The AMPA antagonists can be quinoxalinedione aminoalkylphosphonates, including but not limited to those described in U.S. Pat. No. 6,080,743.

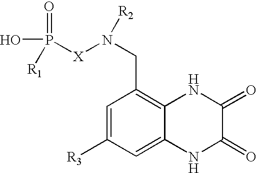

wherein R₁ is hydroxy or (C₁₋₄)alkyl, R₂ is (C₁₋₄)alkyl, R₃ is hydrogen, (C₁₋₄) alkyl, fluorine, chlorine, bromine, trifluoromethyl, cyano or nitro, and X is (C₁₋₆)alkylene, (C₁₋₆)alkylidene, (C₁₋₆)alkylene(C₃₋₆)cycloalkylene or (C₁₋₆)alkylene-(C₃₋₆)cycloalkylidene, wherein the radicals and symbols have the meanings as defined in WO 98/17672; CX 691, EGIS 8332 (7-acetyl-5-(4-aminophenyl)-8,9-dihydro-8-methyl-7H-1,3-dioxolo[4,5-h][2,3]benzodiazepine-8-carbonitrile), GYKI 47261 (4-(8-chloro-2-methyl-11H-imidazo[1,2-c][2,3]benzodiazepine-6-yl)benzenamine), Irampanel (BIIR 561; N,N-dimethyl-2-[2-(3-phenyl-1,2,4-oxadiazol-5-yl)phenoxy]ethanamine), KRP 199 (7-[4-[[[[(4-carboxyphenyl)amino]carbonyl]oxy]methyl]-1H-imidazol-1-y-1]-3,4-dihydro-3-oxo-6-(trifluoromethyl)-2-quinoxalinecarboxylic acid), NS 1209 (2-[[[5-[4-[(dimethylamino)-sulfonyl]phenyl]-1,2,6,7,8,9-hexahydro-8-methyl-2-oxo-3H-pyrrolo[3,2-h]isoquinolin-3-ylidene]amino]oxy]-4-hydroxybutanoic acid monosodium salt, e.g. prepared as described in WO 98/14447), topiramate (TOPAMAX, 2,3:4,5-bis-O-(1-methylethylidene)-beta-D-fructopyranose sulfamate, preparation, e.g. as described in U.S. Pat. No. 535,475) and talampanel ((R)-7-acetyl-5-(4-aminophenyl)-8,9-dihydro-8-methyl-7H-1,3-dioxolo[4,5-h-][2,3]benzodiazepine, preparation, e.g. as described in EP 492485).

The AMPA antagonists also can be selected from CX691, EGIS8332 (7-acetyl-5-(4-aminophenyl)-8,9-dihydro-8-methyl-7H-1,3-dioxolo[4,5-h][2,3]benzodiazepine-8-carbonitrile), GYKI147261 (4-(8-chloro-2-methyl-11H-imidazo[1,2-c][2,3]benzodiazepin-6-yl)benzenamine), Irampanel (BIIR561; N,N-dimethyl-2-[2-(3-phenyl-1,2,4-oxadiazol-5-yl)phenoxy]ethanamine), KRP199 (7-[4-[[[[(4-carboxyphenyl)amino]-carbonyl]oxy]methyl]-1H-imidazol-1-yl]-3,4-dihydro-3-oxo-6-(trifluoromethyl)-2-quinoxalinecarboxylic acid), NS1209 (2-[[[5-[4-[(dimethylamino)sulfonyl]phenyl]-1,2,6,7,8,9-hexahydro-8-methyl-1-2-oxo-3H-pyrrolo[3,2-h]isoquinolin-3-ylidene]amino]oxy]-4-hydroxybutanoic acid monosodium salt), topiramate (TOPAMAX, 2,3:4,5-bis-O-(1-methylethylidene)-beta-D-fructopyranose sulfamate) and talampanel ((R)-7-acetyl-5-(4-aminophenyl)-8,9-dihydro-8-methyl-7H-1,3-dioxolo[4,5-h][2,3]benzodiazepine).

The term “other antiepileptic drugs” as used herein includes, but is not limited to levetiracetam, lamotrigine, gabapentin, sultiam, felbamate, the 1,2,3-1H-triazoles disclosed in EP 114 347, esp. rufinamide [1-(2,6-difluorobenzyl)-1H-[1,2,3]triazole-4-carboxylic acid amide] and the 2-aryl-8-oxodihydropurines disclosed in WO99/28320.

Many of these drugs are metabolized by hepatic enzymes. The body's tolerance response to many AEDs is to increase the amount of hepatic enzymes which reduces the amount of drug available to the system, as well as, the half life of the drug in the body. The metabolism of a drug and its movement through the body (pharmacokinetics) are important in determining its effects, toxicity, and interactions with other drugs.

The three processes governing pharmacokinetics are the absorption of the drug, distribution to various tissues, and elimination of drug metabolites. These processes are intimately coupled to drug metabolism, since a variety of metabolic modifications alter most of the physicochemical and pharmacological properties of drugs, including solubility, binding to receptors, and excretion rates. The metabolic pathways which modify drugs also accept a variety of naturally occurring substrates such as steroids, fatty acids, prostaglandins, leukotrienes and vitamins. The enzymes in these pathways are therefore important sites of biochemical and pharmacological interaction between natural compounds, drugs, carcinogens, mutagens, and xenobiotics.

As discussed above, conventional antiepileptic drug treatments provide for a chronic regimen of constant dosage of pharmacological agents. In contrast, the methods of the present invention are able to manage seizures by titrating the plasma level of the pharmacological agent to correspond to the patient's estimated susceptibility of a seizure. Such titration may be carried out by providing a lower chronic dosing and adjusting the dosing when it is determined that the patient is at an elevated susceptibility to a seizure. In other embodiments the patient may be managed acutely while substantially optimizing the intake of the pharmacological agent by instructing the patient to take a pharmacological agent only when it is determined that a pharmacological agent is necessary, thereby attenuating the tolerance response. Furthermore, with this new paradigm of seizure prevention, the present invention provides a new indication for pharmacotherapy. This new indication is served by several existing medications, including AEDs, given at doses which are sub-therapeutic to their previously known indications, such as acute AED administration for seizure termination or status epilepticus. Since this new indication is served by a new and much lower dosing regimen and consequently a new therapeutic window, the present invention is able to provide a correspondingly new and substantially reduced side effect profile and a reduced tolerance response—which may further increase the length of efficacy of the AEDs.

It has long been appreciated that inherited differences in drug metabolism lead to drastically different levels of drug efficacy and toxicity among individuals. For drugs with narrow therapeutic indices, or drugs which require bioactivation these polymorphisms can be critical. Moreover, promising new drugs are frequently eliminated in clinical trials based on toxicities which may only affect a segment of the patient group. The ability of the present invention to titrate the intake of the drugs may enable efficacious use of such drugs that otherwise would not be brought to market due to side effects and toxicity from a chronic dosing regimen.

The following chart shows some pharmacokinetic data for many of the commonly used pharmaceuticals used to treat epilepsy. The pharmacokinetic data reflects the changes that the body makes in its metabolism of the drug. This is part of the tolerance response that can lead to difficulties determining and maintaining a consistent treatment regimen for patients suffering from seizures.

This chart compares some pharmaceuticals that are used as anti-epileptic drugs. If available, the chart shows data for the bioavailability of the drug, the system responsible for the drug's metabolism, the amount of time it takes for the half of the drug to be metabolized (the half life), and the system responsible for removing the drug or its metabolites from the body. Protein binding is also listed when available. According to the National Library of Medicine, the Medical Subject Heading of Half Life describes the term as: The time it takes for a substance (drug, radioactive nuclide, or other) to lose half of its pharmacologic, physiologic, or radiologic activity. The half-life of the drug in a system decreases as the body improves its ability to metabolize it.

The chart lists many AEDs that are metabolized by the liver (or hepatic system). Since the body metabolizes these drugs by producing hepatic enzymes, the rate at which these AEDs are metabolized increases as the body produces more of the enzyme. When the drug is metabolized or excreted from the system at a faster rate, it reduces the half-life of the drug in the system. In order to compensate for this response, the patient is required to ingest increasing amounts of the drugs more often. It would be a benefit for a person taking one or more AEDs to be able to postpone the body's tolerance response. In the case of the present invention, a patient would have a more accurate and timely method of predicting the imminence of a seizure and could medicate himself as the occasion arose. This method would have the benefit of slowing the tolerance response to a drug since the body would not encounter a daily battle to metabolize the drug and develop the compensating strategies that are commensurate with the tolerance response.

| | | |
|---|---|---|
| Barbiturates | | |
| Barbexaclone | Bioavailability | n/a |
| | Metabolism | n/a |
| | Half life | n/a |
| | Excretion | n/a |
| Metharbital | Bioavailability | n/a |
| | Metabolism | n/a |
| | Half life | n/a |
| | Excretion | n/a |
| Methylphenobarbital | Bioavailability | n/a |
| | Metabolism | n/a |
| | Half life | n/a |
| | Excretion | n/a |
| Phenobarbital | Bioavailability | >95% |
| | Protein binding | 20 to 45% |
| | Metabolism | Hepatic (mostly CYP2C19) |
| | Half life | 53 to 118 hours |
| | Excretion | Renal and fecal |
| Primidone | Bioavailability | >90% |
| | Protein binding | 0.7 |
| | Metabolism | Hepatic |
| | Half life | Primidone: 5-15 hours, |
| | Excretion | Renal |
| Hydantoins | | |
| Ethotoin | Bioavailability | n/a |
| | Metabolism | n/a |
| | Half life | 3 to 9 hours |
| | Excretion | n/a |
| Fosphenytoin | Bioavailability | 1 |
| | Metabolism | n/a |
| | Half life | 15 minutes to convert to phenytoin |
| | Excretion | n/a |
| Mephenytoin | Bioavailability | n/a |
| | Metabolism | n/a |
| | Half life | 7 hours |
| | Excretion | n/a |
| Phenytoin | Bioavailability | 70-100% oral, 24.4% for rectal and intravenous |
| | | administration |
| | Metabolism | hepatic |
| | Half life | 22 hours |
| | Excretion | Primarily through the bile |
| Oxazolidinediones | | |
| Ethadione | Bioavailability | n/a |
| | Metabolism | n/a |
| | Half life | n/a |
| | Excretion | n/a |
| Paramethadione | Bioavailability | n/a |
| | Protein binding | Not significant |
| | Metabolism | n/a |
| | Half life | n/a |
| | Excretion | n/a |
| Trimethadione | Bioavailability | n/a |
| | Metabolism | n/a |
| | Half life | n/a |
| | Excretion | n/a |
| Succinimides | | |
| Ethosuximide | Bioavailability | 93%[1] |
| | Metabolism | Hepatic (CYP3A4, CYP2E1) |
| | Half life | 53 hours |
| | Excretion | Renal (20%) |
| Mesuximide | Bioavailability | n/a |
| | Metabolism | Hepatic (demethylation and glucuronidation) |
| | Half life | 1.4-2.6 hours (mesuximide) |
| | | 28-38 hours (active metabolite) |
| | Excretion | Renal |
| Phensuximide | Bioavailability | n/a |
| | Protein binding | 0.21 |
| | Metabolism | n/a |
| | Half life | n/a |
| | Excretion | n/a |
| Benzodiazepines | | |
| Clobazam | Bioavailability | 0.9 |
| | Metabolism | Hepatic |
| | Half life | 18 hours |
| | Excretion | Renal |
| Clonazepam | Bioavailability | 0.9 |
| | Metabolism | Hepatic CYP3A4 |
| | Half life | 30-40 hours |
| | Excretion | Renal |
| Clorazepate | Bioavailability | 0.91 |
| | Metabolism | Hepatic |
| | Half life | 36-100 hours |
| | Excretion | Renal |
| Diazepam | Bioavailability | 0.93 |
| | Metabolism | Hepatic |
| | Half life | 20-100 hours |
| | Excretion | Renal |
| Lorazepam | Bioavailability | 0.85 |
| | Metabolism | Hepatic |
| | Half life | 10-20 hours |
| | Excretion | Renal |
| Midazolam | Bioavailability | Oral ~36% |
| | | I.M. 90%+ |
| | Metabolism | Hepatic |
| | Half life | 1.8-6.4 hours |
| | Excretion | Renal |
| Nitrazepam | Bioavailability | n/a |
| | Metabolism | Hepatic |
| | Half life | 20 to 40 hours |
| | Excretion | Renal |
| Temazepam | Bioavailability | 0.96 |
| | Metabolism | Hepatic |
| | Half life | 8-20 hours |
| | Excretion | Renal |
| Carboxamides | | |
| Carbamazepine | Bioavailability | 0.8 |
| | Protein binding | 0.76 |
| | Metabolism | hepatic CYP3A4 to active epoxide form |
| | Half life | 25-65 hours |
| | Excretion | 2-3% excreted unchanged in urine |
| Oxcarbazepine | Bioavailability | >95% |
| | Protein binding | n/a |
| | Metabolism | Liver |
| | | (Cytosolic Enzymes & Glucuronic Acid) |
| | Half life | 1-5 hours (healthy adults) |
| | Excretion | Renal |
| Rufinamide | Bioavailability | n/a |
| | Metabolism | n/a |
| | Half life | n/a |
| | Excretion | n/a |
| Fatty acid derivatives | | |
| Valpromide | Bioavailability | n/a |
| | Metabolism | n/a |
| | Half life | n/a |
| | Excretion | n/a |
| Valnoctamide | Bioavailability | 94%[1] |
| | Metabolism | Hepatic |
| | Half life | 10 hours |
| | Excretion | n/a |
| Carboxylic acids | | |
| Valproic acid (Sodium | | |
| valproate & Valproate | | |
| semisodium) | | |
| Tiagabine | Bioavailability | 0.9 |
| | Protein binding | 0.96 |
| | Metabolism | Hepatic (CYP450 system) |
| | Half life | 7-9 hours |
| | Excretion | Fecal and renal |
| GABA analogs | | |
| Gabapentin | Bioavailability | Rapid, in part by saturable carrier-mediated L- |
| | | amino acid transport system |
| | | 60% for 0.9 g daily to 27% for 4.8 g daily dose |
| | | Food increases absorption by 14% |
| | Protein binding | Less than 3% |
| | Metabolism | not appreciably metabolized |
| | Half life | 5 to 7 hours |
| | Excretion | Renal |
| Pregabalin | Bioavailability | ≧90% |
| | Protein binding | Nil |
| | Metabolism | Negligible |
| | Half life | 5-6.5 hours |
| | Excretion | Renal |
| Progabide | Bioavailability | 0.6 |
| | Protein binding | 0.95 |
| | Metabolism | Hepatic |
| | Half life | 4 hours |
| | Excretion | Renal |
| Vigabatrin | Bioavailability | 80-90% |
| | Protein binding | 0 |
| | Metabolism | Almost no metabolic transformation occurs |
| | Half life | 5-8 hours in young adults, 12-13 hours in the |
| | | elderly. |
| | Excretion | Renal |
| Others | | |
| Monosaccharides | | |
| Topiramate | Bioavailability | 0.8 |
| | Metabolism | 30% hepatic, 70% is excreted unchanged |
| | Half life | 19 to 23 hours |
| | Excretion | 70% renal (in urine) in unchanged form |
| Aromatic allylic | | |
| alcohols | | |
| Stiripentol | Bioavailability | n/a |
| | Metabolism | n/a |
| | Half life | n/a |
| | Excretion | n/a |
| Ureas | | |
| Phenacemide | Bioavailability | n/a |
| | Metabolism | n/a |
| | Half life | 22-25 hours. |
| | Excretion | n/a |
| Pheneturide | Bioavailability | n/a |
| | Metabolism | n/a |
| | Half life | n/a |
| | Excretion | n/a |
| Carbamates | Bioavailability | n/a |
| Emylcamate | Metabolism | n/a |
| | Half life | n/a |
| | Excretion | n/a |
| Felbamate | Bioavailability | >90% |
| | Metabolism | Hepatic |
| | Half life | 20-23 hours |
| | Excretion | n/a |
| Meprobamate | Bioavailability | n/a |
| | Metabolism | Hepatic |
| | Half life | 10 hours |
| | Excretion | Renal |
| Pyrrolidines | | |
| Brivaracetam | N/A | |
| Levetiracetam | Bioavailability | 1 |
| | Metabolism | Renal |
| | Half life | 6-8 hours |
| | Excretion | Renal |
| Nefiracetam/Piracetam | Bioavailability | ~100% |
| | Metabolism | n/a |
| | Half life | 4-5 hours |
| | Excretion | Urinary |
| Seletracetam | N/A | |
| Sulfa drugs | | |
| Acetazolamide | Bioavailability | n/a |
| | Metabolism | None |
| | Half life | 3 to 9 hours |
| | Excretion | Renal |
| Ethoxzolamide | Bioavailability | n/a |
| | Protein binding | ~89% |
| | Metabolism | n/a |
| | Half life | 2.5-5.5 hours |
| | Excretion | n/a |
| Sultiame | Bioavailability | 100% (oral) |
| | Protein binding | 0.29 |
| | Metabolism | Hepatic secretion |
| | Half life | 24 hour |
| | Excretion | Fecal (10%) and renal (90%) |
| Zonisamide | Bioavailability | n/a |
| | Protein binding | 0.4 |
| | Metabolism | Hepatic |
| | Half life | 105 hours in red blood cells, 63 hours in |
| | | plasma |
| | Excretion | Renal |
| Propionates | | |
| Beclamide | Bioavailability | n/a |
| | Metabolism | n/a |
| | Half life | n/a |
| | Excretion | n/a |
| Aldehydes | | |
| Paraldehyde | Bioavailability | n/a |
| | Metabolism | n/a |
| | Half life | n/a |
| | Excretion | n/a |
| Bromides | | |
| Potassium bromide | N/A | |
| | Bioavailability | 0.98 |
| | Protein binding | 0.55 |
| Lamotrigine | Metabolism | Hepatic |
| | Half life | 24-34 hours (healthy adults) |
| | Excretion | Renal |

F. Prediction Methods and Systems

The following description describes the methods and systems of the present invention that are used to monitor the patient's condition. In specific embodiments, the present invention provides systems and methods that predict the onset of a seizure by characterizing a patient's susceptibility to a future seizure. The systems and methods may thereafter facilitate an appropriate action for managing (e.g., preventing, reducing a magnitude, or reducing a duration of the seizure) the future seizure, while modulating a drug response (e.g., tolerance) of the patient's AED.

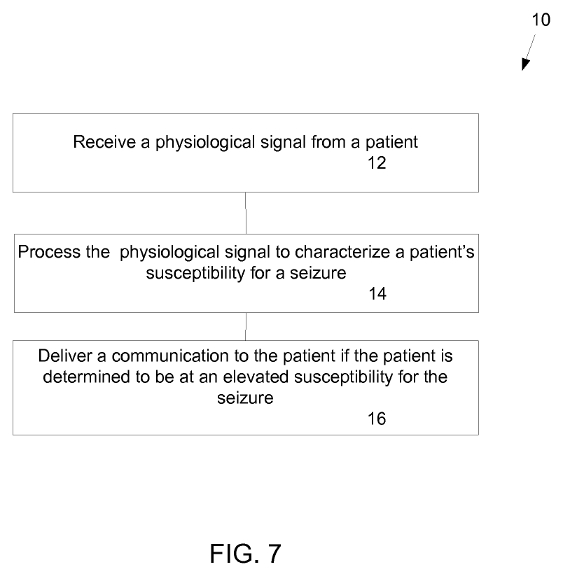

FIG. 7 illustrates a simplified method 10 encompassed by the present invention. In the illustrated embodiment, a physiological signal (e.g., EEG signal) is received from the patient (Step 12). One or more parameters are extracted from the signal and processed (e.g., classified) to determine if the patient is at an increased or elevated susceptibility or propensity for a future seizure (Step 14). If the patient is determined to have an elevated susceptibility, a signal can be generated.

In one embodiment, the generated signal may be a control signal that is delivered to a therapy assembly—such as a pulse generator or implanted drug pump. The control signal may be used to facilitate automatic delivery of a therapy to the patient. In preferred embodiments, one or more parameters of the therapy will be titrated to the patient's estimated susceptibility to the seizure.

Typically, however, the signal is in the form of a communication signal that is delivered to the patient (Step 16). The communication may prompt or facilitate the patient to take an acute dosage of an AED, adjust the timing or dosage of a chronically prescribed AED, or perform some other appropriate action to prevent or alleviated the predicted seizure.

Advantageously, the methods and system of the present invention allow a physician to customize the communication provided to the patient and to customize preventative therapy for specific propensity levels, time horizons, probabilities, including making recommendations for specific doses of certain medications that have efficacy in the prevention of seizures. This actionable information is valuable for all patients, and more so for cognitively impaired patients; the presentation of actionable information elicits improved compliance in comparison to a simple seizure prediction or probability estimation, which is more apt to elicit anxiety which can negatively impact compliance.

Certain patients can benefit from certain actions, when performed in a timeframe preceding a seizure. For example, the appropriate action is typically in the form of manual or automatic delivery of an AED. In preferred aspects, parameters of the AED intervention (and the communication to the patient) can be titrated (e.g., co-related to or a function of the prediction of the seizure) and customized for the particular patient. For example, if the patient's propensity for the seizure is low and/or a long time horizon is estimated for the seizure, the dosage of the recommended AED could be lower, a different type of AED could be recommended, or the like. On the other hand, if patient's propensity for the seizure is high or a short time horizon is estimated for the seizure, the dosage of the recommended AED could be higher, a faster acting AED could be recommended, or the like. As noted above, such methods reduce, and may eliminate, the tolerance response that plagues conventional AED regimens.

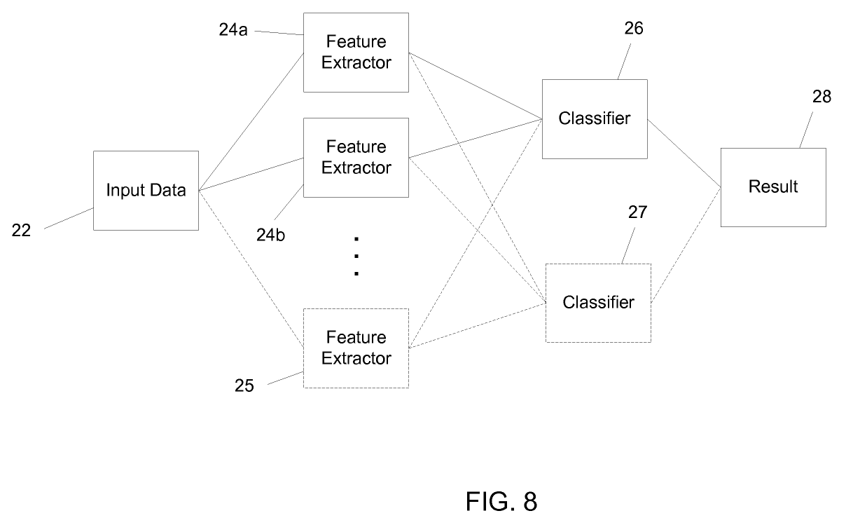

FIG. 8 depicts an example of the overall structure of a system for estimating a propensity for the onset of a neurological event such as, for example, an epileptic seizure. The input data 22 may comprise representations of physiological signals obtained from monitoring a subject. Any number of signal channels may be used. Examples of physiological signals that may be used as input data 22 include, but are not limited to, electrical signals generated by electrodes placed on or within the brain or nervous system (EEG signals), temperature of the brain or of portions of the brain, blood pressure or blood flow measurements, blood oxygenation via pulse oximetry measurements, ECG/EKG, blood pH, chemical concentrations of neurotransmitters, chemical concentrations of medications, combinations of the preceding, and the like.

The input data may be in the form of analog signal data or digital signal data that has been converted by way of an analog to digital converter (not shown). The signals may also be amplified, preprocessed, and/or conditioned to filter out spurious signals or noise. For purposes of simplicity the input data of all of the preceding forms is referred to herein as input data 102.

The input data 22 from the selected physiological signals is supplied to one or more feature extractors 24a, 24b, 25. A feature extractor 24a, 24b, 25 may be, for example, a set of computer executable instructions stored on a computer readable medium, or a corresponding instantiated object or process that executes on a computing device. Certain feature extractors may also be implemented as programmable logic or as circuitry. In general, a feature extractor 24a, 24b, 25 can process data 22 and identify some characteristic of the data 22. Such a characteristic of the data is referred to herein as an extracted feature.

Each feature extractor 24a, 24b, 25 may be univariate (operating on a single input data channel), bivariate (operating on two data channels), or multivariate (operating on multiple data channels). Some examples of potentially useful characteristics to extract from signals for use in determining the subject's propensity for a neurological event, include but are not limited to, bandwidth limited power (alpha band [8-13 Hz], beta band [13-18 Hz], delta band [0.1-4 Hz], theta band [4-8 Hz], low beta band [12-15 Hz], mid-beta band [15-18 Hz], high beta band [18-30 Hz], gamma band [30-48 Hz], high frequency power [>48 Hz], bands with octave or half-octave spacings, wavelets, etc.), second, third and fourth (and higher) statistical moments of the EEG amplitudes or other features, spectral edge frequency, decorrelation time, Hjorth mobility (HM), Hjorth complexity (HC), the largest Lyapunov exponent L(max), effective correlation dimension, local flow, entropy, loss of recurrence LR as a measure of non-stationarity, mean phase coherence, conditional probability, brain dynamics (synchronization or desynchronization of neural activity, STLmax, T-index, angular frequency, and entropy), line length calculations, first, second and higher derivatives of amplitude or other features, integrals, combinations thereof, relationships thereof including ratios and differences. Of course, for other neurological conditions, additional or alternative characteristic extractors may be used with the systems described herein.

The extracted characteristics can be supplied to one or more classifiers 26, 27. Like the feature extractors 24a, 24b, 25, each classifier 26, 27 may be, for example, a set of computer executable instructions stored on a computer readable medium or a corresponding instantiated object or process that executes on a computing device. Certain classifiers may also be implemented as programmable logic or as circuitry. In some embodiments, some classifiers 27 may be optionally applied or omitted in various circumstances. For example, when the application of one or more classifiers 26 is sufficient to estimate that a propensity for a neurological event is sufficiently low, then other classifiers 27 may not be applied to the extracted characteristics. If the classifiers 26 indicate a higher propensity for a neurological event, then additional classifiers 27 may be applied to the extracted characteristics.

The classifiers 26, 27 analyze one or more of the extracted characteristics, and either alone or in combination with each other (and possibly other subject dependent parameters), provide a result 28 that may characterize, for example, a subject's condition. The output from the classifiers may then be used to determine the output communication that is provided to the subject regarding their condition. As described above, the classifiers 26, 27 are trained by exposing them to training measurement vectors, typically using supervised methods for known classes, e.g. ictal, and unsupervised methods as described above for classes that can't be identified a priori, e.g. contra-ictal. Some examples of classifiers include k-nearest neighbor (“KNN”), linear or non-linear regression, Bayesian, mixture models based on Gaussians or other basis functions, neural networks, and support vector machines (“SVM”). Each classifier 26, 27 may provide a variety of output results, such as a logical result or a weighted result. The classifiers 26, 27 may be customized for the individual subject and may be adapted to use only a subset of the characteristics that are most useful for the specific subject. Additionally, over time, the classifiers 26, 27 may be further adapted to the subject, based, for example, in part on the result of previous analyses and may reselect extracted characteristics that are used for the specific subject.

As it relates to epilepsy, for example, one implementation of a classification of neural conditions defined by the classifiers 26, 27 may include (1) a contra-ictal condition (sometimes referred to herein as a safe or protected condition), (2) an inter-ictal condition (sometimes referred to as a “normal” condition), (3) a pre-ictal condition (sometimes referred to as an “abnormal” or “pre-seizure” condition) or a pro-ictal condition, (4) an ictal condition (sometimes referred to as a “seizure” condition), and (5) a post-ictal condition (sometimes referred to as a “post-seizure” condition). In another embodiment, it may be desirable to have the classifier classify the subject as being in one of two conditions—e.g., a pro-ictal condition or inter-ictal condition—which could correspond, respectively, to either an elevated or high propensity for a future seizure or a low propensity for a future seizure.

As noted above, instead of providing a logical answer, it may be desirable for a classifier 26, 27 to provide a weighted answer so as to further delineate within the pro-ictal condition to further allow the system to provide a more specific output communication for the subject. For example, instead of a simple logical answer (e.g., pro-ictal or inter-ictal) it may be desirable to provide a weighted output or other output that quantifies the subject's propensity, probability, likelihood and/or risk of a future neurological event using some predetermined scale (e.g., scale of 1-10, with a “1” meaning “normal” and a “10” meaning a neurological event is imminent). For example, if it is determined that the subject has an increased propensity for a neurological event (e.g., subject has entered the pro-ictal condition), but the neurological event is likely to occur on a long time horizon, the output signal could be weighted to be reflective of the long time horizon, e.g., an output of “5”. However, if the output indicates that the subject is pro-ictal and it is predicted that the neurological event is imminent within the next 10 minutes, the output could be weighted to be reflective of the shorter time horizon to the neurological event, e.g., an output of “9.” On the other hand, if the subject is normal, the system may provide an output of “1”.

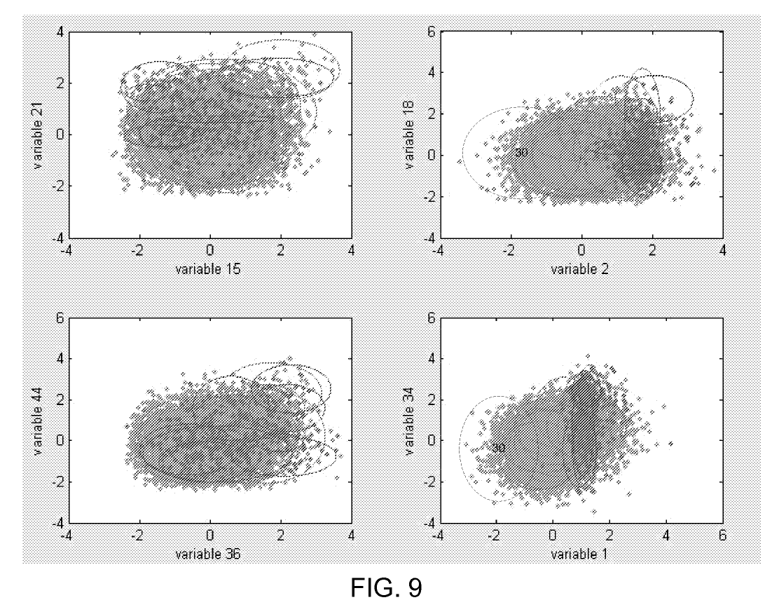

Other implementations involve classifier 26 outputs expressing the inter-ictal and pro-ictal conditions as a continuum, with a scalar or vector of parameters describing the actual condition and its variations. FIG. 9 illustrates an example of 2-dimensional projections of an N-dimensional feature space. The dark data points (feature vectors) are pro-ictal feature vectors that occur within 20 minutes of the subsequent seizure and the lighter points are inter-ictal feature vectors that occur more than 20 minutes prior to a seizure. As shown in the projection onto variables 15 and 21 and variables 36 and 44 in the left column of FIG. 9, there does not appear to be any differentiable clusters or groupings between the two groups. However, for the projection onto variable 2 and 18 and variable 1 and 34 in the right column of FIG. 9, there is a more defined separation between the two classes. While the pro-ictal class does overlap the inter-ictal class there is an area outlined by the dotted lines 30 in both two-dimensional projections that is free of pro-ictal feature vectors and separated in time from transitioning into the pro-ictal or ictal class devoid of any vectors that occur within 20 minutes of subsequent seizure. Thus, for this particular example, while the particular features may not be able to determine if the patient is in a pro-ictal condition, the combination of features should be able to determine if the patient is in a contra-ictal condition in which the patient is safe from transitioning into an ictal state for a time period.

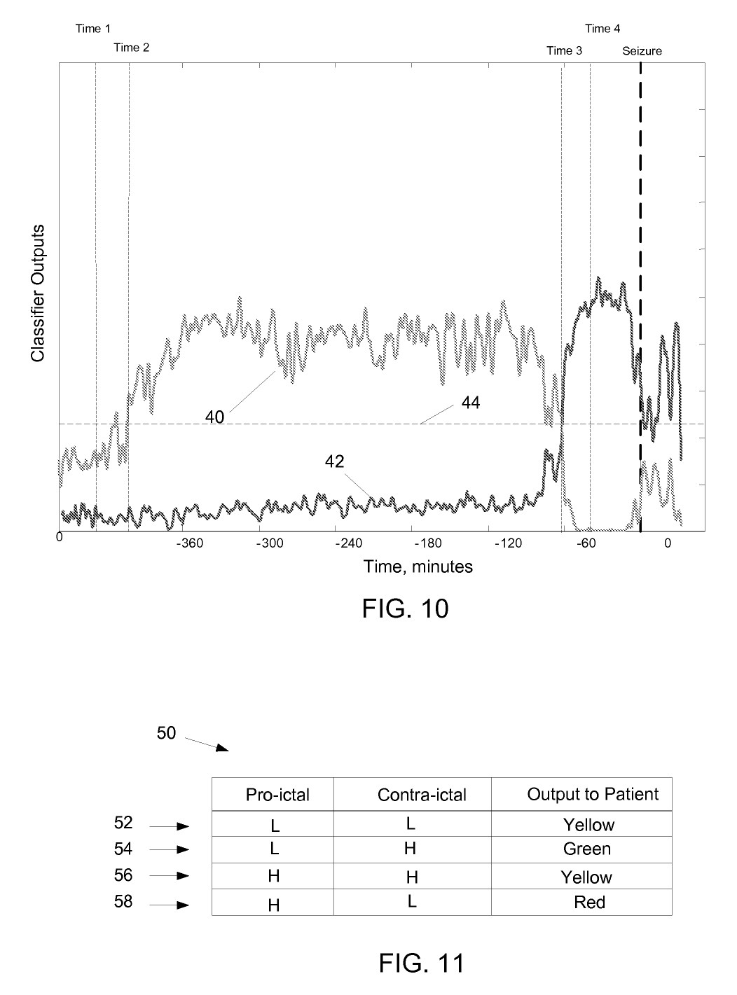

FIGS. 10 and 11 illustrate how the outputs from the two two-state classifiers may be used to determine the output communication provided to the patient and/or a control signal transmitted to a therapy assembly. FIG. 10 illustrates an example of the output from the contra-ictal classifier 40 overlaid on an output from the pro-ictal classifier 42. The right-most dotted line indicates where the seizure started. FIG. 11 is a truth table 50 that processes the outputs from the classifiers to determine the output communication provided to the patient.

The truth table 50 of FIG. 11 shows the different possible combinations of outputs from the each of the classifiers and the associated output communication provided to the patient. In one simplified embodiment, the potential output to the patient includes a green light, a yellow light and a red light. A green light 54 may indicate to the patient that they are at a low susceptibility to a seizure for a time period. A yellow light 52, 56 (or some other indication) may indicate to the patient to proceed with caution. Such an indication does not necessarily mean that the patient is at a high susceptibility to have a seizure, but it does mean that they are not “protected” from a seizure. Finally, a red light 58 (or some other indication) may indicate to the patient that they are at an elevated susceptibility for a seizure.

It should be appreciated however, that while FIGS. 10 and 11 describe providing an output to the patient in the form of yellow lights, green lights and red lights, the present invention embodies systems which do not provide a communication to the patient, but instead delivers a therapy to the patient automatically and embodies any number of different type of outputs may be provided to the patient to indicate their condition. The outputs may be different displays on a screen to the patient, different tactile outputs (e.g., vibrations), different sounds, different lights, or any combination thereof.

Referring again to FIG. 10, at Time 1, both classifier outputs 40, 42 are considered to below an artificially specified threshold 44 and are both considered to be “low.” For ease of description, a single threshold is illustrated in FIG. 11, but in other embodiments, the pro-ictal classifier and contra-ictal classifier may have different thresholds. In this embodiment, anything below the threshold 44 indicates that there is a low likelihood that the patient is in a pro-ictal state and/or a low likelihood that the patient is in a contra-ictal state. Since such outputs 40, 42 from the classifiers are inconclusive and appear to conflict with each other, the output communication provided to the patient may indicate that that the patient should proceed with caution. One example of such an output communication is a yellow light. This output corresponds to the first row 52 of the truth table 50 of FIG. 11.

At Time 2, the output 40 from the contra-ictal classifier is high (H) and the output from the pro-ictal classifier 42 is low (L). Such a classification indicates that there is a low likelihood that the patient has an increased susceptibility for a seizure and a high likelihood of being in a protected state. These classifiers appear to be consistent with each other; consequently, the output communication provided to the patient may indicate that the patient is safe. One example of such an output communication is the display of a green light. This scenario corresponds to the second row 54 of FIG. 11.

As shown in FIG. 10, the green light would stay on until Time 3 where the output 40 from the contra-ictal classifier is trending lower but is still above threshold 44 (is high (H)) and the output 42 from the pro-ictal classifiers transitions to high (H). As shown in the third row 56 of the truth table of FIG. 11, when both classifier outputs are high (H)—which indicates a high likelihood that the patient is at an increased susceptibility to a seizure and a high likelihood that the patient is in a protected condition (inconsistent outputs)—an output communication is output to the patent to indicate that they should proceed with caution (e.g., yellow light).

Finally, at Time 4 in FIG. 10, the output 40 from the contra-ictal classifier has fully transitioned to low (L) (e.g., low likelihood that the patient is in a protected condition) and the output 42 from the pro-ictal classifier is above threshold 44 and is high (H) (e.g., high likelihood that the patient is at an increased susceptibility to a seizure). This scenario corresponds with the fourth row 58 of FIG. 8 and the red light would be output to the patient—which indicates that the patient has a high susceptibility to a seizure and should take an appropriate action.

While FIGS. 10 and 11 illustrate the use of two two-class classifiers, any number and type of classifier may be used by the systems of the present invention. For example, in other embodiments it may be desirable to have a single classifier classify the patient as being in one of three conditions—an inter-ictal class, a pro-ictal class, and a contra-ictal class—which could correspond, respectively, to a normal propensity for a future seizure, an elevated or high propensity for a future seizure, and a low propensity for a future seizure.

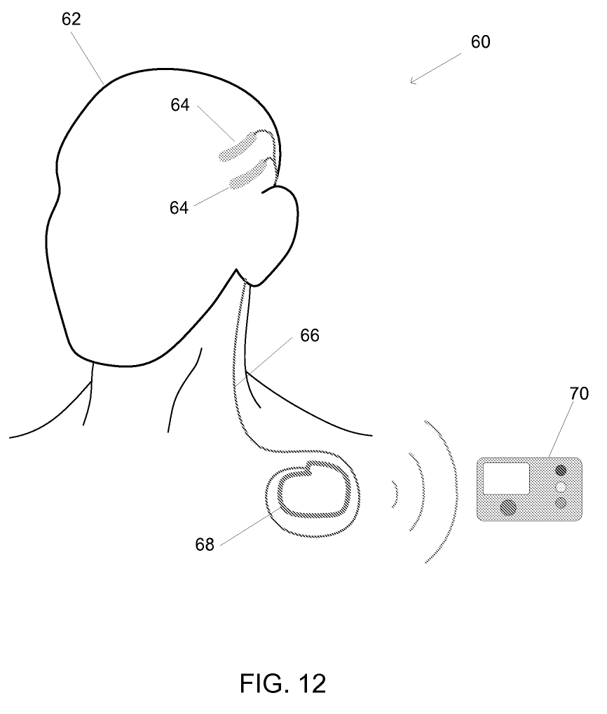

FIG. 12 illustrates a device system in which the feature extractors and classifiers of the present invention may be embodied. The system 60 is used to monitor a subject 62 for purposes of measuring physiological signals and predicting neurological events. The system 60 of the embodiment provides for substantially continuous sampling of brain wave electrical signals such as in electroencephalograms or electrocorticograms (referred to collectively as “EEGs”).

The system 60 comprises one or more sensors 64 configured to measure signals from the subject 62. The sensors 64 may be located anywhere on the subject 62. In the exemplary embodiment, the sensors 64 are configured to sample electrical activity from the subject's brain, such as EEG signals. The sensors 64 may be attached to the surface of the subject's body (e.g., scalp electrodes), attached to the skull (e.g., subcutaneous electrodes, bone screw electrodes, etc.), or, preferably, may be implanted intracranially in the subject 62 (e.g., subdural, epidural, deep brain). In one embodiment, one or more of the sensors 64 will be implanted adjacent a previously identified epileptic focus, a portion of the brain where such a focus is believed to be located, or adjacent a portion of a seizure network.

Any number of sensors 64 may be employed, but the sensors 64 will typically include between 1 sensor and 16 sensors. The sensors may take a variety of forms. In one embodiment, the sensors comprise grid electrodes, strip electrodes and/or depth electrodes which may be permanently implanted through burr holes in the head. Exact positioning of the sensors will usually depend on the desired type of measurement. In addition to measuring brain activity, other sensors (not shown) may be employed to measure other physiological signals from the subject 202.

In an embodiment, the sensors 64 will be configured to substantially continuously sample the brain activity of the groups of neurons or one or more individual neurons (e.g., one or more microelectrodes) in the immediate vicinity of the sensors 64. The sensors 204 are electrically joined via cables 66 to an implanted communication unit 68. In one embodiment, the cables 66 and communication unit 68 will be implanted in the subject 62. For example, the communication unit 68 may be implanted in a subclavicular cavity of the subject 62. In alternative embodiments, the cables 66 and communication unit 68 may be attached to the subject 62 externally or implanted in other portions of the patient's body (e.g., in an opening in the skull).

In one embodiment, the communication unit 68 is configured to facilitate the sampling of signals from the sensors 64. Sampling of brain activity is typically carried out at a rate above about 200 Hz, and preferably between about 200 Hz and about 1000 Hz, and most preferably at about 400 Hz. The sampling rates could be higher or lower, depending on the specific conditions being monitored, the subject 202, and other factors. Each sample of the subject's brain activity is typically encoded using between about 8 bits per sample and about 32 bits per sample, and preferably about 16 bits per sample.

In alternative embodiments, the communication unit 68 may be configured to measure the signals on a non-continuous basis. In such embodiments, signals may be measured periodically or aperiodically.

An external data device 70 is preferably carried external to the body of the subject 62. The external data device 70 receives and stores signals, including measured signals and possibly other physiological signals, from the communication unit 68. External data device 70 could also receive and store extracted features, classifier outputs, patient inputs, etc. Communication between the external data device 70 and the communication unit 68 may be carried out through wireless communication. The wireless communication link between the external data device 70 and the communication unit 68 may provide a one-way or two-way communication link for transmitting data. In alternative embodiments, it may be desirable to have a direct communications link from the external data device 70 to the communication unit 68, such as, for example, via an interface device positioned below the subject's skin. The interface (not shown) may take the form of a magnetically attached transducer that would enable power to be continuously delivered to the communication unit 68 and would provide for relatively higher rates of data transmission. Error detection and correction methods may be used to help insure the integrity of transmitted data. If desired, the wireless data signals can be encrypted prior to transmission to the external data device 70.

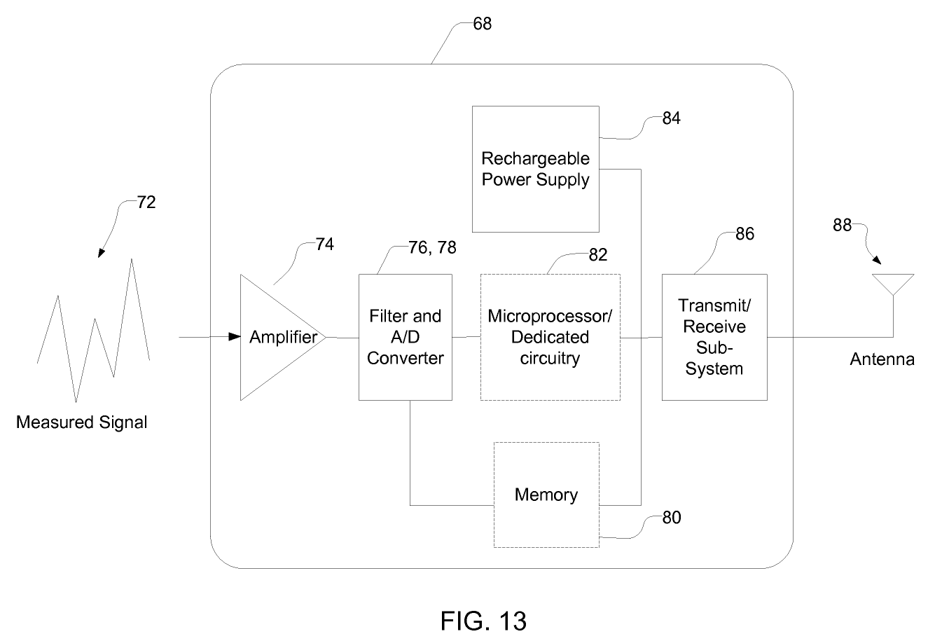

FIG. 13 depicts a block diagram of one embodiment of a communication unit 68 that may be used with the systems and methods described herein. Energy for the system is supplied by a rechargeable power supply 84, but may also be a non-rechargeable power supply. The rechargeable power supply may be a battery, or the like. The rechargeable power supply 84 may also be in communication with a transmit/receive subsystem 86 so as to receive power from outside the body by inductive coupling, radiofrequency (RF) coupling, etc. Power supply 84 will generally be used to provide power to the other components of the implantable device. Signals 72 from the sensors 64 are received by the communication unit 68. The signals may be initially conditioned by an amplifier 74, a filter 76, and an analog-to-digital converter 78. A memory module 80 may be provided for storage of some of the sampled signals prior to transmission via a transmit/receive subsystem 86 and antenna 88 to the external data device 70. For example, the memory module 80 may be used as a buffer to temporarily store the conditioned signals from the sensors 64 if there are problems with transmitting data to the external data device 70, such as may occur if the external data device 70 experiences power problems or is out of range of the communications system. The external data device 70 can be configured to communicate a warning signal to the subject in the case of data transmission problems to inform the subject and allow him or her to correct the problem.

The communication unit 68 may optionally comprise circuitry of a digital or analog or combined digital/analog nature and/or a microprocessor, referred to herein collectively as “microprocessor” 82, for processing the signals prior to transmission to the external data device 70. The microprocessor 82 may execute at least portions of the analysis as described herein. For example, in some configurations, the microprocessor 82 may run one or more feature extractors 24a, 24b, 25 (FIG. 8) that extract characteristics of the measured signal that are relevant to the purpose of monitoring. Thus, if the system is being used for diagnosing or monitoring epileptic subjects, the extracted characteristics (either alone or in combination with other characteristics) may be indicative or predictive of a neurological event. Once the characteristic(s) are extracted, the microprocessor 82 may transmit the extracted characteristic(s) to the external data device 70 and/or store the extracted characteristic(s) in memory 80. Because the transmission of the extracted characteristics is likely to include less data than the measured signal itself, such a configuration will likely reduce the bandwidth requirements for the communication link between the communication unit 68 and the external data device 70.

In some configurations, the microprocessor 82 in the communication unit 68 may run one or more classifiers 26, 27 (FIG. 8) as described above. The result 28 (FIG. 8) of the classification may be communicated to the external data device 70.

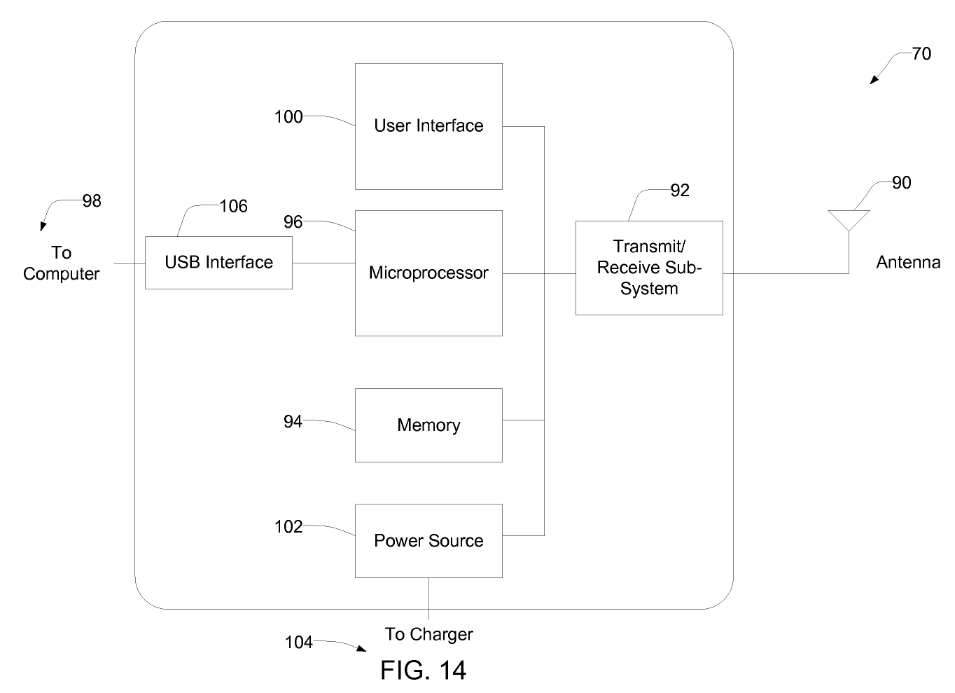

While the external data device 70 may include any combination of conventional components, FIG. 14 provides a schematic diagram of some of the components that may be included. Signals from the communication unit 68 are received at an antenna 90 and conveyed to a transmit/receive subsystem 92. The signals received may include, for example, a raw measured signal, a processed measured signal, extracted characteristics from the measured signal, a result from a classifier that ran on the implanted microprocessor 82, or any combination thereof.

The received data may thereafter be stored in memory 94, such as a hard drive, RAM, EEPROM, removable flash memory, or the like and/or processed by a microprocessor, application specific integrated circuit (ASIC) or other dedicated circuitry of a digital or analog or combined digital/analog nature, referred to herein collectively as a “microprocessor” 96. Data may be transmitted from memory 94 to microprocessor 96 where the data may optionally undergo additional processing. For example, if the transmitted data is encrypted, it may be decrypted. The microprocessor 96 may also comprise one or more filters that filter out high-frequency artifacts (e.g., muscle movement artifacts, eye-blink artifacts, chewing, etc.) so as to prevent contamination of the high frequency components of the measured signals.

Microprocessor 96 may also be configured to request that the communication unit 68 perform various checks (e.g., sensor impedance checks) or calibrations prior to signal recording and/or at specified times to ensure the proper functioning of the system.

External data device 70 will typically include a user interface 100 for displaying outputs to the subject and for receiving inputs from the subject. The user interface will typically comprise outputs such as auditory devices (e.g., speakers) visual devices (e.g., LCD display, LEDs, etc.), tactile devices (e.g., vibratory mechanisms), or the like, and inputs, such as a plurality of buttons, a touch screen, and/or a scroll wheel.

The user interface may be adapted to allow the subject to indicate and record certain events. For example, the subject may indicate that medication has been taken, the dosage, the type of medication, meal intake, sleep, drowsiness, occurrence of an aura, occurrence of a neurological event, or the like. Such inputs may be used in conjunction with the measured physiological signals to improve the analysis of the patient's condition, or the inputs may simply be stored for later analysis by the physician.

The LCD display may be used to output a variety of different communications to the subject including, status of the device (e.g., memory capacity remaining), battery state of one or more components of system, whether or not the external data device 70 is within communication range of the communication unit 68, a warning (e.g., a neurological event warning), a prediction (e.g., a neurological event prediction), a recommendation (e.g., “take medicine”), or the like. It may be desirable to provide an audio output or vibratory output to the subject in addition to or as an alternative to the visual display on the LCD.

External data device 70 may also include a power source 102 or other conventional power supply that is in communication with at least one other component of external data device 70. The power source 102 may be rechargeable. If the power source 102 is rechargeable, the power source may optionally have an interface for communication with a charger 104. While not shown in FIG. 14, external data device 70 will typically comprise a clock circuit (e.g., oscillator and frequency synthesizer) to provide the time base for synchronizing the external data device 70 and the communication unit 68.

Referring again to FIG. 12, in a preferred embodiment, most or all of the processing of the signals received by the communication unit 68 is done in an external data device 70 that is external to the subject's body. In such embodiments, the communication unit 68 would receive the signals from subject and may or may not pre-process the signals and transmit some or all of the measured signals transcutaneously to an external data device 70, where the analysis of the signals (e.g., feature extraction and classification) and possible therapy determination is made. Advantageously, such embodiments reduce the amount of computational processing power that needs to be implanted in the subject, thus potentially reducing power consumption and increasing battery life in the implanted communication unit 68. Furthermore, by having the processing external to the subject, the judgment or decision making components of the system may be more easily reprogrammed or custom tailored to the subject without having to reprogram the communication unit 68.

In alternative embodiments, the predictive systems disclosed herein and treatment systems responsive to the predictive systems may be embodied in the communication unit 68 that is implanted in the subject's body or distributed between the implanted communication unit 68 and the external data device 70. For example, in one embodiment the predictive system of FIG. 8 may be stored in and processed by the communication unit 68 that is implanted in the subject's body. In such embodiments, the subject's propensity for neurological event characterization (or whatever output is generated by the predictive system that is predictive of the onset of the neurological event) is transmitted to the external data device 70, and the external processor performs any remaining processing to generate and display the output from the predictive system and communicate this to the patient. Such embodiments have the benefit of sharing processing power, while reducing the communications demands on the communication unit 68.

In other embodiments, the signals 72 may be processed in a variety of ways in the communication unit 68 before transmitting data to the external data device 70 so as to reduce the total amount of data to be transmitted, thereby reducing the power demands of the transmit/receive subsystem 86. Examples include: digitally compressing the signals before transmitting them; selecting only a subset of the measured signals for transmission; selecting a limited segment of time and transmitting signals only from that time segment; extracting salient characteristics of the signals, transmitting data representative of those characteristics rather than the signals themselves, and transmitting only the result of classification. Further processing and analysis of the transmitted data may take place in the external data device 70.

In yet other embodiments, it may be possible to perform some of the prediction in the communication unit 68 and some of the prediction in the external data device 70. For example, one or more characteristics from the one or more signals may be extracted with feature extractors in the communication unit 68. Some or all of the extracted characteristics may be transmitted to the external data device 70 where the characteristics may be classified to predict the onset of a neurological event. If desired, external data device 70 may be customizable to the individual subject. Consequently, the classifier may be adapted to allow for transmission or receipt of only the characteristics from the communication unit 68 that are predictive for that individual subject. Advantageously, by performing feature extraction in the communication unit 68 and classification in an external device at least two benefits may be realized. First, the amount of wireless data transmitted from the communication unit 68 to the external data device 70 is reduced (versus transmitting pre-processed data). Second, classification, which embodies the decision or judgment component, may be easily reprogrammed or custom tailored to the subject without having to reprogram the implanted communication unit 68.

In yet another embodiment, feature extraction may be performed external to the body. Pre-processed signals (e.g., filtered, amplified, converted to digital) may be transcutaneously transmitted from communication unit 68 to the external data device 70 where one or more characteristics are extracted from the one or more signals with feature extractors. Some or all of the extracted characteristics may be transcutaneously transmitted back into the communication unit 68, where a second stage of processing may be performed on the characteristics, such as classifying of the characteristics (and other signals) to characterize the subject's propensity for the onset of a future neurological event. If desired, to improve bandwidth, the classifier may be adapted to allow for transmission or receipt of only the characteristics from the subject communication assembly that are predictive for that individual subject. Advantageously, because feature extractors may be computationally expensive and power hungry, it may be desirable to have the feature extractors external to the body, where it is easier to provide more processing and larger power sources.

G. Therapeutic Agents—Methods of Use

The conventional use of therapeutic agents (AEDs) are used to treat one of two indications: (1) to reduce the frequency of seizures, and (2) to terminate seizures once they have begun. For the first indication, antiepileptic drugs designed to have a long half life are dosed to maintain a desired level of a blood plasma concentration of the drug. By maintaining stable blood plasma concentrations of the AEDs, the seizure threshold is increased and the frequency of seizures that occur is usually reduced. This is an “open-loop” approach to therapy, in which therapy is stable and is not adjusted in response to any changes in the patient's propensity for a seizure. An example is the use of phenyloin (Dilantin), which is given preferably once every 8 hours, but whose half life is long enough to permit once daily dosing in less compliant or capable patents.

For the second indication, AEDs are used to terminate a seizure after it has begun and has become clinically evident. In these indications, the seizure has already generalized, and the patient is typically incapacitated. Another person, either a family member or medical caregiver, administers a medication to terminate the seizure. Examples include (A) rectal diazepam (diastat) which can be given by family members or medical personnel and (B) intravenous lorazepam, which is typically given once a patient has been admitted to the hospital for treatment.

The methods taught in the present invention provide novel approaches to the treatment of epilepsy:

In one aspect of the invention, the dosing and administration of a chronically taken antiepileptic drug is titrated to, co-related to or a function of a probability and/or a predicted time horizon that a patient has before the epileptic seizure is predicted to occur. For such embodiments, the patient will typically continue to be on a chronic regimen of the antiepileptic drug. The dosage of the antiepileptic drug will typically be lower than conventional dosages. If the systems of the present invention determine that the patient has an elevated susceptibility for a seizure, the patient may be prompted to adjust the timing or dosage of the chronically prescribed AED. Typically, the longer the predicted amount of time and lower probability, the lower the subsequent dose of the epileptic drug, and vice-versa. Also, the route of administration can also vary based on the timing of the prediction and probability. In other embodiments, the dosage/form of the antiepileptic drug may be the same no matter the patient's graded propensity or risk of a seizure—and the system will merely adjust the timing of the next dosage.

In another aspect of the invention, rather than provide chronic, continuous levels of medication which are unchanged despite changes in the patient's propensity for the seizure or wait until a seizure has incapacitated the patient, the present invention provides for the acute, preventative delivery of a pharmacological agent, preferably an antiepileptic drug, that can modulate the patient's propensity for the seizure and prevent the further progression into a state that facilitates or predisposes to a seizure state. Preferably, the dosing and administration of an antiepileptic drug is titrated to, co-related to or a function of the patient's propensity for the future seizure, this characterization typically being related to the measured neural state, or the like.

In a preferred aspect, a lower dose of an antiepileptic drug is administered to a patient. This dose can be about 5% to about 95% lower than the recommended dose for the drug, and preferably at or below 90% of the recommended dose, and most preferably below about 50% of the recommended dose. This lower dose is preferably administered acutely to perturb the patient's neural state and reduce the patient's propensity for seizures. Tables 1 and 2 provide some examples of dosages of some antiepileptic drugs and formulation types that can be administered to a patient based on a prediction horizon. The prediction horizon is the amount of time after which the patient could have an epileptic seizure and is directly correlated to the propensity or probability of having a seizure. For example, a one minute prediction horizon means that the prediction algorithm has predicated that the patient is at relatively high propensity for a seizure and will likely have an epileptic seizure in about 1 minute. The column on the left side of the “Drug Dosing” portion of the chart illustrates the conventional “recommended dosage,” and the columns to the right of the “recommended dosage” illustrate some examples of the potential reduced dosage, based on the prediction horizon. While not shown in Tables 1 and 2, similar tables could be provided that are based on the patient's neural state or propensity for seizure. Thus, instead of having the prediction horizon as headings, the corresponding neural state or propensity for seizure can be used.

TABLE 1

| Anti-Epileptic | Drug Dosing (mg) Levels needed if given a Prediction Horizon (min): | | | | | | | |
|---|---|---|---|---|---|---|---|---|
| Drug (Pediatric | After | | | | | | | |
| Dosing | Onset | 1 | 5 | 10 | 15 | 20 | 25 | 30 |
| Buccal | 0.5 | 0.25 | 0.125 | 0.0625 | 0.03125 | 0.015625 | 0.007813 | 0.003906 |
| Midazolam | | | | | | | | |
| Intranasal | 0.2 | 0.1 | 0.05 | 0.025 | 0.125 | 0.00625 | 0.003125 | 0.001563 |
| Midazolam | | | | | | | | |
| IM Midazolam | 0.2 | 0.1 | 0.05 | 0.025 | 0.125 | 0.00625 | 0.003125 | 0.001563 |
| Rectal Diazepam | 0.5 | 0.25 | 0.125 | 0.0625 | 0.03125 | 0.015625 | 0.007813 | 0.003906 |
| IV Lorezepam | 0.1 | 0.05 | 0.025 | 0.0125 | 0.00625 | 0.003125 | 0.001563 | 0.000781 |
| IV Diazepam | 0.3 | 0.15 | 0.075 | 0.0375 | 0.01875 | 0.009375 | 0.004688 | 0.002344 |

TABLE 2

| Anti-Epileptic | | | | | | | | |
|---|---|---|---|---|---|---|---|---|
| Drug (Adult | Drug Dosing (mg) Levels needed if given a Prediction Horizon (min): | | | | | | | |
| Dosing) | After Onset | 1 | 5 | 10 | 15 | 20 | 25 | 30 |
| Rectal Diazepam | 10 | 5 | 2.5 | 1.25 | 0.625 | 0.3125 | 0.15625 | 0.078125 |
| Lorazepam | 4 | 2 | 1 | 0.5 | 0.25 | 0.125 | 0.625 | 0.3125 |
| Diazepam | 10 | 5 | 2.5 | 1.25 | 0.625 | 0.3125 | 0.156 | 0.078125 |

The dose administered to the patient is useful to prevent the occurrence of the future seizures. Preferably, the dose is related to the type of AED being administered, the type of formulation, and/or the pharmacokinetics of the drug and formulation.

TABLE 3

| | | | | Approximate |
|---|---|---|---|---|
| | | | | Dose |
| | | | | Compared to |
| | | | | (dose used in |
| | | Prediction | Time to Clinical | seizure |
| Drug | Formulation | Horizon | Onset | Termination) |
| Midazolam | Buccal | 5 to 30 minutes | 5 to 8 minutes | 20-30% (0.5 mg/kg) |
| Midazolam | Intranasal | 1 to 20 minutes | 30 sec to 2 | 10-25% (0.2 mg/kg) |
| | | | minutes | |
| Diazepam | Rectal | 10 to 30 minutes | 5 to 15 minutes | 10-25% (0.3 mg/kg) |
| Midazolam | Intramuscular | 1 to 30 minutes | 1 to 5 minutes | 5-20% (0.2 mg/kg) |
| Midazolam | Intravenous | 1 to 10 minutes | 1 to 5 minutes | 5-20% (0.2 mg/kg) |

Another aspect of the invention is a method for preventing or otherwise managing epileptic seizures. One embodiment involves administration of an effective amount of an antiepileptic drug to a patient. The acute administration can be provided locally to a nervous system component or delivered systemically to the patient. The acute administration is provided at a time prior to a possible occurrence of a seizure. Typically, this time is about greater than 30 seconds, and preferably between about 1 minute to about 90 minutes, and more preferably between about 30 minutes and about 60 minutes. The dose of AED administered is typically between 5% and 95% lower than a dose of said drug that is effective after a seizure has occurred, and preferably less than about 50% of the drug that is effective after the seizure has occurred. In some cases, it can be possible to reduce the dosage of the drug to be between about 50% and about 5% of the drug that is effective after the seizure has occurred, but depending on the propensity, it can be possible to reduce the dosage even greater. The amount of AED administered can also be a function of the time before a seizure can occur. That is, the longer the time before a seizure can occur, the smaller the dose of the AED administered. This administration is typically an acute administration and could comprise about 2 to about 10 doses being administered, preferably all the doses being administered before the occurrence of a seizure.

The dose of drug administered can be greater than or equal to about 100% of the dose normally administered to patients. However, the preferred dose of the AEDs administered herein is a fraction of the normal dose. This normal dose is typically the dose that is considered to be an effective dose in the art (or by the FDA) to reduce and/or eliminate the occurrence of a seizure after a seizure has occurred. The dose used in the invention herein could also be a fraction of the dose that has been used and has been found effective in a particular patient or a sub-population of patients. That is, in some patients it is possible that the dose used is higher or lower than the recommended dose, and in these patients the dose administered is a fraction of the dose that is effective in reducing and/or eliminating the occurrence of a seizure in them after a seizure has occurred. The normal dose can be found for different patient populations and/or different kinds of seizures in text books, the Physician's Desk Reference, or approved by a regulatory agency, such as the Food and Drug Administration (FDA). Optionally, the system can be utilized with a particular patient or sub-population of patients to identify the optimum drug, the appropriate dosage for that patient, and/or the dosage that correlates to the prediction horizon or expected onset of the seizure by evaluating the data from the system and modifying the treatment accordingly.

It is also worthy of note that combinations of two or more antiepileptic drugs can be an effective strategy for treating epileptic seizures. In fact, the combination can have a greater effect than the mere additive effect of each drug alone. The list of these drugs comprises but is not limited to barbiturates and derivatives thereof, benzodiazepines, carboxamides, hydantoins, succinimides, valproic acid and other fatty acid derivates, AMPA antagonists and other antiepileptic drugs. This is especially important when the patient's response to monotherapy has become refractory or experience other tolerance responses. Embodiments of the present invention can be extended to preventing the tolerance response when one or more drugs are used in the prevention of a seizure.

Since the systems of the present invention are able to record and store the patient's brain activity signals, the stored data will provide insight into the effectiveness of the AEDs and will allow the physician to assess the efficacy of the AEDs on the patient's brain activity. If the dosing, timing, or type of AED is seen to lose its efficacy over time, the systems and information provided by the systems of the present invention will enable the physician to make changes to the patient's drugs, drug regimen, communication outputs from the system, etc.

H. Treatment Regimes

The invention provides pharmaceutical compositions comprising one or a combination of therapeutic agents, for example, formulated together with a pharmaceutically acceptable carrier. Some compositions include a combination of multiple (e.g., two or more) antiepileptic drugs of the invention. Such pharmaceutical compositions are used in the treatment, preferably prevention, of epilepsy and epilepsy-related diseases and conditions, as described in detail above.

In some aspects, the therapeutic agents can be used in combination with one or more other compounds or with one or more other forms. The two or more compounds can be formulated together, in the same dosage unit e.g. in one cream, patch, suppository, tablet, capsule, or packet of powder to be dissolved in a beverage; or each compound can be formulated in a separate unit, e.g., two creams, two patches, two suppositories, two tablets, two capsules, a tablet and a liquid for dissolving the tablet, a packet of powder and a liquid for dissolving the powder, and the like.

As used herein “pharmaceutically acceptable carrier” includes any and all solvents, dispersion media, coatings, antibacterial and antifungal agents, isotonic and absorption delaying agents, and the like that are physiologically compatible. In one aspect, the carrier is suitable for parenteral administration. Alternatively, the carrier can be suitable for intravenous, intraperitoneal or intramuscular administration. In another aspect, the carrier is suitable for oral administration. Pharmaceutically acceptable carriers include sterile aqueous solutions or dispersions and sterile powders for the extemporaneous preparation of sterile injectable solutions or dispersion. The use of such media and agents for pharmaceutically active substances is well known in the art. Except insofar as any conventional media or agent is compatible with the active compound, use thereof in the pharmaceutical compositions is contemplated. Supplementary active compounds can also be incorporated into the compositions.

The therapeutic agents of the present invention can be administered as a pharmaceutically acceptable salt. A “pharmaceutically acceptable salt” refers to a salt that retains the desired biological activity of the parent compound and does not impart any undesired toxicological effects (See, e.g., Berge, et al., J. Pharm. Sci,. 66: 1, 1977). Examples of such salts include acid addition salts and base addition salts. Acid addition salts include those derived from nontoxic inorganic acids, such as hydrochloric, nitric, phosphoric, sulfuric, hydrobromic, hydroiodic, phosphorous and the like, as well as from nontoxic organic acids such as aliphatic mono- and dicarboxylic acids, phenyl-substituted alkanoic acids, hydroxy alkanoic acids, aromatic acids, aliphatic and aromatic sulfonic acids and the like. Base addition salts include those derived from alkaline earth metals, such as sodium, potassium, magnesium, calcium and the like, as well as from nontoxic organic amines, such as N,N′-dibenzylethylenediamine, N-methylglucamine, chloroprocaine, choline, diethanolamine, ethylenediamine, procaine and the like.

In prophylactic applications, pharmaceutical compositions or medicaments are administered to a patient susceptible to, or otherwise at risk of a disease or condition (i.e., epilepsy or an epilepsy-related disease or disorder) in an amount sufficient to eliminate or reduce the risk, lessen the severity, or delay the outset of the disease, including biochemical, histologic and/or behavioral symptoms of the disease, its complications and intermediate pathological phenotypes presenting during development of the disease. In therapeutic applications, compositions or medicants are administered to a patient suspected of, or already suffering from such a disease or condition in an amount sufficient to cure, or at least partially arrest, the symptoms of the disease or condition (e.g., biochemical and/or histologic), including its complications and intermediate pathological phenotypes in development of the disease or condition. An amount adequate to accomplish therapeutic or prophylactic treatment is defined as a therapeutically- or prophylactically-effective dose. In both prophylactic and therapeutic regimes, agents are usually administered in several dosages until a sufficient response has been achieved. Typically, the response is monitored and repeated dosages are given if the response starts to wane.

The pharmaceutical composition of the present invention should be sterile and fluid to the extent that the composition is deliverable by syringe. In addition to water, the carrier can be an isotonic buffered saline solution, ethanol, polyol (for example, glycerol, propylene glycol, and liquid polyetheylene glycol, and the like), and suitable mixtures thereof. Proper fluidity can be maintained, for example, by use of coating such as lecithin, by maintenance of required particle size in the case of dispersion and by use of surfactants. In many cases, it is preferable to include isotonic agents, for example, sugars, polyalcohols such as mannitol or sorbitol, and sodium chloride in the composition. Long-term absorption of the injectable compositions can be brought about by including in the composition an agent which delays absorption, for example, aluminum monostearate or gelatin.

When the active therapeutic agent or compound is suitably protected, as described above, the therapeutic agent or compound can be orally administered, for example, with an inert diluent or an assimilable edible carrier.

In some aspects, a therapeutic agent or compound can be administered in combination with one or more other compounds, forms, and/or agents, e.g., as described above. Pharmaceutical compositions comprising combinations with one or more other active agents can be formulated to comprise certain molar ratios. The two compounds, forms and/or agents can be formulated together, in the same dosage unit e.g. in one cream, patch suppository, tablet, capsule, or packet of powder to be dissolved in a beverage; or each compound, form, and/or agent can be formulated in separate units, e.g., two creams, two patches, suppositories, tablets, two capsules, a tablet and a liquid for dissolving the tablet, a packet of powder and a liquid for dissolving the powder, and the like.

If necessary or desirable, the compounds and/or combinations of therapeutic agents or compounds can be administered with still other agents. The choice of agents that can be co administered with the compounds and/or combinations of therapeutic agents of the instant invention can depend, at least in part, on the condition being treated. Pharmaceutical compositions of the invention also can be administered in combination therapy, i.e., combined with other agents.

I. Routes of Administration

A composition of the present invention can be administered by a variety of methods known in the art. The route and/or mode of administration vary depending upon the desired results. The phrases “parenteral administration” and “administered parenterally” mean modes of administration other than enteral and topical administration, usually by injection, and includes, without limitation, intravenous, intramuscular, intraarterial, intrathecal, intracapsular, intraorbital, intracardiac, intradermal, intraperitoneal, transtracheal, subcutaneous, subcuticular, intraarticular, subcapsular, subarachnoid, intraspinal, epidural and intrasternal injection and infusion. The peptide of the invention can be administered parenterally by injection or by gradual infusion over time. The peptide can also be prepared with carriers that protect the compound against rapid release, such as a controlled release formulation, including implants, transdermal patches, and microencapsulated delivery systems. Further methods for delivery of the peptide include orally, by encapsulation in microspheres or proteinoids, by aerosol delivery to the lungs, or transdermally by iontophoresis or transdermal electroporation. To administer a peptide of the invention by certain routes of administration, it can be necessary to coat the compound with, or co-administer the compound with, a material to prevent its inactivation. The method of the invention also includes delivery systems such as microencapsulation. Microencapsulation also allows co-entrapment of therapeutic agents. Liposomes in the blood stream are generally taken up by the liver and spleen. Pharmaceutically acceptable diluents include saline and aqueous buffer solutions. Liposomes include water-in-oil-in-water CGF emulsions as well as conventional liposomes (Strejan, et al., J. Neuroimmunol., 7: 27, 1984). Biodegradable, biocompatible polymers can be used, such as ethylene vinyl acetate, polyanhydrides, polyglycolic acid, collagen, polyorthoesters, and polylactic acid. Many methods for the preparation of such formulations are described by e.g., Sustained and Controlled Release Drug Delivery Systems, J. R. Robinson, Ed., 1978, Marcel Dekker, Inc., New York. Other methods of administration will be known to those skilled in the art.

Preparations for parenteral administration of a therapeutic agent of the invention include sterile aqueous or non-aqueous solutions, suspensions, and emulsions. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's, or fixed oils. Intravenous vehicles include fluid and nutrient replenishers, electrolyte replenishers (such as those based on Ringer's dextrose), and the like. Preservatives and other additives can also be present such as, for example, antimicrobials, anti-oxidants, chelating agents, and inert gases and the like.

Therapeutic compositions typically must be sterile, substantially isotonic, and stable under the conditions of manufacture and storage. The composition can be formulated as a solution, microemulsion, liposome, or other ordered structure suitable to high drug concentration. The carrier can be a solvent or dispersion medium containing, for example, water, ethanol, polyol (for example, glycerol, propylene glycol, and liquid polyethylene glycol, and the like), and suitable mixtures thereof. The proper fluidity can be maintained, for example, by the use of a coating such as lecithin, by the maintenance of the required particle size in the case of dispersion and by the use of surfactants. In many cases, it is preferable to include isotonic agents, for example, sugars, polyalcohols such as mannitol, sorbitol, or sodium chloride in the composition. Prolonged absorption of the injectable compositions can be brought about by including in the composition an agent that delays absorption, for example, monostearate salts and gelatin.

Sterile injectable solutions can be prepared by incorporating the active compound in the required amount in an appropriate solvent with one or a combination of ingredients enumerated above, as required, followed by sterilization microfiltration. Generally, dispersions are prepared by incorporating the active compound into a sterile vehicle that contains a basic dispersion medium and the required other ingredients from those enumerated above. In the case of sterile powders for the preparation of sterile injectable solutions, the preferred methods of preparation are vacuum drying and freeze-drying (lyophilization) that yield a powder of the active ingredient plus any additional desired ingredient from a previously sterile-filtered solution thereof. Therapeutic compositions can also be administered with medical devices known in the art. For example, in a preferred aspect, a therapeutic composition of the invention can be administered with a needleless hypodermic injection device, such as the devices disclosed in, e.g., U.S. Pat. No. 5,399,163, 5,383,851, 5,312,335, 5,064,413, 4,941,880, 4,790,824, or 4,596,556. Examples of implants and modules useful in the present invention include: U.S. Pat. No. 4,487,603, which discloses an implantable micro-infusion pump for dispensing medication at a controlled rate; U.S. Pat. No. 4,486,194, which discloses a therapeutic device for administering medicants through the skin; U.S. Pat. No. 4,447,233, which discloses a medication infusion pump for delivering medication at a precise infusion rate; U.S. Pat. No. 4,447,224, which discloses a variable flow implantable infusion apparatus for continuous drug delivery; U.S. Pat. No. 4,439,196, which discloses an osmotic drug delivery system having multi-chamber compartments; and U.S. Pat. No. 4,475,196, which discloses an osmotic drug delivery system. Many other such implants, delivery systems, and modules are known and may be used either in an open loop or closed loop fashion with the systems of the present invention.

Pharmacological agents can also be administered by intranasal, intraocular, intravaginal, and intrarectal routes including suppositories, insufflation, powders and aerosol formulations (for examples of steroid inhalants, see Rohatagi, J. Clin. Pharmacol. 35:1187, 1995; Tjwa, Ann. Allergy Asthma Immunol. 75:107, 1995).

For example, some aspects can also include at least one pharmacological agent in an aerosolized, atomized or nebulized vapor form, e.g., administrable via a metered dose device or nebulizer, and the like such that aspects also include aerosolizing, vaporing or nebulizing one or more pharmacological agents for administration to a subject. Accordingly, for administration to the upper (nasal) or lower respiratory tract by inhalation, one or more therapeutic compositions or agents of the invention can be conveniently delivered from a nebulizer or a pressurized pack or other convenient means of delivering an aerosol spray. Pressurized packs can comprise a suitable propellant such as dichlorodifluoromethane, trichlorofluoromethane, dichlorotetrafluoroethane, carbon dioxide or other suitable gas. In the case of a pressurized aerosol, the dosage unit can be determined by providing a valve to deliver a metered amount. Nebulizers include, but are not limited to, those described in U.S. Pat. Nos. 4,624,251; 3,703,173; 3,561,444; and 4,635,627. Aerosol delivery systems of the type disclosed herein are available from numerous commercial sources including Fisons Corporation (Bedford, Mass.), Schering Corp. (Kenilworth, N.J.) and American Pharmoseal Co., (Valencia, Calif.). For intra-nasal administration, the therapeutic agent can also be administered via nose drops, a liquid spray, such as via a plastic bottle atomizer or metered-dose inhaler. Typical of atomizers are the Mistometer (Wintrop) and the Medihaler (Riker).

When the therapeutic agents of the present invention are administered as pharmaceuticals, to humans and animals, they can be given alone or as a pharmaceutical composition containing, for example, 0.01 to 99.5% (or 0.1 to 90%) of active ingredient in combination with a pharmaceutically acceptable carrier.

Again by way of representative example, a therapeutic agent can be introduced into an animal body by application to a bodily membrane capable of absorbing the protein, for example the nasal, gastrointestinal and rectal membranes.

In some aspects relating to topical/local application, the pharmaceutical compositions can include one or more penetration enhancers. For example, the formulations can comprise suitable solid or gel phase carriers or excipients that increase penetration or help delivery of compounds or combinations of compounds of the invention across a permeability barrier, e.g., the skin. Many of these penetration-enhancing compounds are known in the art of topical formulation, and include, e.g., water, alcohols (e.g., terpenes like methanol, ethanol, 2-propanol), sulfoxides (e.g., dimethyl sulfoxide, decylmethyl sulfoxide, tetradecylmethyl sulfoxide), pyrrolidones (e.g., 2-pyrrolidone, N-methyl-2-pyrrolidone, N-(2-hydroxyethyl)pyrrolidone), laurocapram, acetone, dimethylacetamide, dimethylformamide, tetrahydrofurfuryl alcohol, L-α-amino acids, anionic, cationic, amphoteric or nonionic surfactants (e.g., isopropyl myristate and sodium lauryl sulfate), fatty acids, fatty alcohols (e.g., oleic acid), amines, amides, clofibric acid amides, hexamethylene lauramide, proteolytic enzymes, α-bisabolol, d-limonene, urea and N,N-diethyl-m-toluamide, and the like. Additional examples include humectants (e.g., urea), glycols (e.g., propylene glycol and polyethylene glycol), glycerol monolaurate, alkanes, alkanols, ORGELASE, calcium carbonate, calcium phosphate, various sugars, starches, cellulose derivatives, gelatin, and/or other polymers. In some aspects, the pharmaceutical compositions will include one or more such penetration enhancers.

The therapeutic agent is typically applied to the absorptive membrane in conjunction with a permeation enhancer. (See, e.g., V. H. L. Lee, Crit. Rev. Ther. Drug Carrier Syst. 5:69, 1988; V. H. L. Lee, J. Controlled Release 13:213, 1990; V. H. L. Lee, Ed., Peptide and Protein Drug Delivery, Marcel Dekker, New York, 1991; DeBoer, A. G., et al., J. Controlled Release 13:241, 1990). For example, STDHF is a synthetic derivative of fusidic acid, a steroidal surfactant that is similar in structure to the bile salts, and has been used as a permeation enhancer for nasal delivery. (Lee, W. A., Biopharm., Nov./Dec. 22, 1990).

Administration “in combination with” one or more further therapeutic agents includes simultaneous (concurrent) and consecutive administration in any order.

J. Effective Dosages

The therapeutic agent (e.g., an AED) is administered in a therapeutically effective amount. “Therapeutically effective amount” as used herein for treatment of epilepsy and related diseases and conditions refers to the amount of a therapeutic agent used that is of sufficient quantity to reduce the incidence, extent or severity of epilepsy or related diseases and conditions in a mammal comprising administering to the mammal prior to, concurrent with or after the onset of a condition expected to epilepsy an amount of a therapeutic agent effective to attain said reduction. The dosage ranges for the administration of the therapeutic agents are those large enough to produce the desired effect. The amount of therapeutic agent adequate to accomplish this is defined as a “therapeutically effective dose.” The dosage schedule and amounts effective for this use, i.e., the “dosing regimen,” will depend upon a variety of factors, including the stage of the disease or condition, the severity of the disease or condition, the nature of any concurrent treatment, the general state of the patient's health, the patient's physical status, age, pharmaceutical formulation and concentration of active agent, and the like. In calculating the dosage regimen for a patient, the mode of administration also is taken into consideration. The dosage regimen must also take into consideration the pharmacokinetics, i.e., the pharmaceutical composition's rate of absorption, bioavailability, metabolism, clearance, and the like. See, e.g., the latest Remington's (Remington's Pharmaceutical Science, Mack Publishing Company, Easton, Pa.); Egleton, Peptides 18: 1431, 1997; Langer, Science 249: 1527, 1990. The dosage regimen can be adjusted by the individual physician in the event of any contraindications.

Dosage regimens of the pharmaceutical compositions of the present invention are adjusted to provide the optimum desired response (e.g., a therapeutic response). For example, a single bolus can be administered, several divided doses can be administered over time or the dose can be proportionally reduced or increased as indicated by the exigencies of the therapeutic situation. It is especially advantageous to formulate parenteral compositions in dosage unit form for ease of administration and uniformity of dosage. Dosage unit form as used herein refers to physically discrete units suited as unitary dosages for the subjects to be treated; each unit contains a predetermined quantity of active compound calculated to produce the desired therapeutic effect in association with the required pharmaceutical carrier. The specification for the dosage unit forms of the invention are dictated by and directly dependent on (a) the unique characteristics of the active compound and the particular therapeutic effect to be achieved, and (b) the limitations inherent in the art of compounding such an active compound for the treatment of sensitivity in individuals.

Actual dosage levels of the active ingredients in the pharmaceutical compositions of the present invention can be varied so as to obtain an amount of the active ingredient which is effective to achieve the desired therapeutic response for a particular patient, composition, and mode of administration, without being toxic to the patient. The selected dosage level depends upon a variety of pharmacokinetic factors including the activity of the particular compositions of the present invention employed, or the ester, salt or amide thereof, the route of administration, the time of administration, the rate of excretion of the particular compound being employed, the duration of the treatment, other drugs, compounds and/or materials used in combination with the particular compositions employed, the age, sex, weight, condition, general health and prior medical history of the patient being treated, and like factors.

A physician or veterinarian can start doses of the compounds of the invention employed in the pharmaceutical composition at levels lower than that required to achieve the desired therapeutic effect and gradually increase the dosage until the desired effect is achieved. In general, a suitable daily dose of a compound of the invention is that amount of the compound which is the lowest dose effective to produce a therapeutic effect. Such an effective dose generally depends upon the factors described above. It is preferred that administration be intravenous, intramuscular, intraperitoneal, or subcutaneous, or administered proximal to the site of the target. If desired, the effective daily dose of a therapeutic composition can be administered as two, three, four, five, six or more sub-doses administered separately at appropriate intervals throughout the day, optionally, in unit dosage forms. While it is possible for a compound of the present invention to be administered alone, it is preferable to administer the compound as a pharmaceutical formulation (composition).

For any therapeutic agents, the effective dose can be estimated initially in any appropriate animal model (e.g., primate, rats and guinea pigs and other laboratory animals). The animal model is also typically used to achieve a desirable concentration range and route of administration. Such information can then be used to determine useful doses and routes for administration in humans or other mammals.

Therapeutic efficacy and possible toxicity of the therapeutic agents can be determined by standard pharmaceutical procedures in experimental animals (e.g., ED₅₀, the dose therapeutically effective in 50% of the population; and LD₅₀, the dose lethal to 50% of the population). The dose ratio between therapeutic and toxic effects is the therapeutic index, and it can be expressed as the ratio ED₅₀/LD₅₀. Therapeutic agents, which exhibit large therapeutic indices, are preferred. The data obtained from animal studies is used in formulating a range of dosage for use in humans or other mammals. The dosage of such compounds lies preferably within a range of circulating concentrations that include the ED₅₀ with little or no toxicity. The dosage typically varies within this range depending upon the dosage form employed, sensitivity of the patient, and the route of administration.

The dosage and frequency of administration can vary depending on whether the treatment is prophylactic or therapeutic. In prophylactic applications, a relatively low dosage is administered at relatively infrequent intervals over a long period of time. Some patients continue to receive treatment for the rest of their lives. In therapeutic applications, a relatively high dosage at relatively short intervals is sometimes required until progression of the disease is reduced or terminated, and preferably until the patient shows partial or complete amelioration of symptoms of disease. Thereafter, the patent can be administered a prophylactic regime.

Thus, the administration of the therapeutic agents in accordance with the present invention can be in a single dose, in multiple doses, in a continuous or intermittent manner, depending, for example, upon the recipient's physiological condition, whether the purpose of the administration is therapeutic or prophylactic, and other factors known to skilled practitioners. The administration of the agents of the invention can be essentially continuous over a preselected period of time or can be in a series of spaced doses. Both local and systemic administration is contemplated.

For the patients in which the therapeutic agent is administered to the mammal on multiple occasions (e.g., daily), the therapeutic agent can be administered to a mammal at least once per day for a period of from 1 day to 20 days, or from 1 day to 40 days, or from 1 day to 60 days to reduce the incidence, extent or severity of epilepsy and epilepsy-related diseases and conditions in a mammal prior to, concurrent with or after the onset of a condition expected to lead to epilepsy or epilepsy-related diseases or conditions. The therapeutic agent of the invention (e.g., an AED) can also be administered up to 1, 2, 3, 4, 5, 6, 7, 8, 9, 10, 11, 12, 24, or 48 hours prior the onset of a condition expected to lead to epilepsy or epilepsy-related diseases or conditions. The therapeutic agent of the invention (e.g., an AED) can also be administered up to 1, 2, 3, 4, 5, 6, 7, 8, 9, 10, 11, 12, 24, 30, 60, 90 or more minutes prior the onset of a condition expected to lead to epilepsy or epilepsy-related diseases or conditions. The therapeutic agent (e.g., AED) can also be administered to the mammal intermittently or continuously for at least 12 or 24 or 48 hours or more after the onset of a condition expected to lead to epilepsy or epilepsy-related diseases or conditions. As discussed above, the therapeutic agent can also be administered with at least one additional agent. The abbreviation “ng” is an abbreviation for nanogram, or nanograms, as appropriate. The abbreviation “mg” is an abbreviation for milligram, or milligrams, as appropriate. The abbreviation “kg” is an abbreviation for kilogram, or kilograms, as appropriate.

Some compounds of the invention can be formulated to ensure proper distribution in vivo. For example, the blood-brain barrier (BBB) excludes many highly hydrophilic compounds. To ensure that the therapeutic compounds of the invention cross the BBB (if desired), they can be formulated, for example, in liposomes. For methods of manufacturing liposomes, See, e.g., U.S. Pat. Nos. 4,522,811; 5,374,548; and 5,399,331. The liposomes can comprise one or more moieties which are selectively transported into specific cells or organs, thus enhance targeted drug delivery (See, e.g., Ranade, J. Clin. Pharmacol., 29: 685, 1989). Exemplary targeting moieties include folate or biotin (See, e.g., U.S. Pat. No. 5,416,016 to Low, et al.); mannosides (Umezawa, et al., Biochem. Biophys. Res. Commun., 153: 1038, 1988); antibodies (Bloeman, et al., FEBS Lett., 357: 140, 1995; Owais, et al., Antimicrob. Agents Chemother., 39: 180, 1995); surfactant protein A receptor (Briscoe, et al., Am. J. Physiol., 1233: 134, 1995), different species of which can comprise the formulations of the inventions, as well as components of the invented molecules; p120 (Schreier, et al., J. Biol. Chem., 269: 9090, 1994); See also Keinanen, et al., FEBS Lett., 346: 123, 1994; Killion, et al., Immunomethods, 4: 273, 1994. In some methods, the therapeutic compounds of the invention are formulated in liposomes; in a more preferred aspect, the liposomes include a targeting moiety. In some methods, the therapeutic compounds in the liposomes are delivered by bolus injection to a site proximal to the tumor or infection. The composition should be fluid to the extent that easy syringability exists. It should be stable under the conditions of manufacture and storage and should be preserved against the contaminating action of microorganisms such as bacteria and fungi.

K. Formulation

Typically, compositions are prepared as injectables, either as liquid solutions or suspensions; solid forms suitable for solution in, or suspension in, liquid vehicles prior to injection can also be prepared. The preparation also can be emulsified or encapsulated in liposomes or micro particles such as polylactide, polyglycolide, or copolymer for enhanced adjuvant effect, as discussed above. Langer, Science 249: 1527, 1990 and Hanes, Advanced Drug Delivery Reviews 28: 97, 1997. The agents of this invention can be administered in the form of a depot injection or implant preparation which can be formulated in such a manner as to permit a sustained or pulsatile release of the active ingredient.

Additional formulations suitable for other modes of administration include oral, intranasal, and pulmonary formulations, suppositories, and transdermal applications.

The therapeutic agents of the invention (e.g., AEDs) for oral administration can be formulated using pharmaceutically acceptable carriers well known in the art, in dosages suitable for oral administration. Such carriers enable the therapeutic agents to be formulated as tablets, pills, dragees, capsules, liquids, gels, syrups, slurries, suspensions, etc., suitable for ingestion by a subject.

For oral administration, the compounds can be formulated readily by combining the active compound(s) with pharmaceutically acceptable carriers well known in the art. Such carriers enable the compounds of the invention to be formulated as tablets, including chewable tablets, pills, dragees, capsules, lozenges, hard candy, liquids, gels, syrups, slurries, powders, suspensions, elixirs, wafers, and the like, for oral ingestion by a patient to be treated. Such formulations can comprise pharmaceutically acceptable carriers including solid diluents or fillers, sterile aqueous media and various non-toxic organic solvents. Generally, the compounds of the invention will be included at concentration levels ranging from about 0.5%, about 5%, about 10%, about 20%, or about 30% to about 50%, about 60%, about 70%, about 80% or about 90% by weight of the total composition of oral dosage forms, in an amount sufficient to provide a desired unit of dosage.

Aqueous suspensions for oral use can contain compound(s) of this invention with pharmaceutically acceptable excipients, such as a suspending agent (e.g., methyl cellulose), a wetting agent (e.g., lecithin, lysolecithin and/or a long-chain fatty alcohol), as well as coloring agents, preservatives, flavoring agents, and the like.

Therapeutic agents, which can be used orally, can be formulated, for example, as push-fit capsules made of gelatin, as well as soft, sealed capsules made of gelatin and a coating such as glycerol or sorbitol. Push-fit capsules can contain therapeutic agents mixed with filler or binders such as lactose or starches, lubricants such as talc or magnesium stearate, and, optionally, stabilizers. In soft capsules, the therapeutic agents can be dissolved or suspended in suitable liquids, such as fatty oils, liquid paraffin, or liquid polyethylene glycol with or without stabilizers.

Pharmaceutical preparations for oral use can be obtained as a solid excipient, optionally grinding a resulting mixture, and processing the mixture of granules, after adding suitable auxiliaries, if desired, to obtain tablets or dragee cores. Suitable excipients are, in particular, fillers such as sugars, including lactose, sucrose, mannitol, or sorbitol; flavoring elements, cellulose preparations such as, for example, maize starch, wheat starch, rice starch, potato starch, gelatin, gum tragacanth, methyl cellulose, hydroxypropylmethyl-cellulose, sodium carboxymethylcellulose, and/or polyvinyl pyrrolidone (PVP). If desired, disintegrating agents can be added, such as the cross-linked polyvinyl pyrrolidone, agar, or alginic acid or a salt thereof such as sodium alginate. The compounds can also be formulated as a sustained release preparation.

Dragee cores can be provided with suitable coatings such as concentrated sugar solutions, which can also contain gum arabic, talc, polyvinylpyrrolidone, carbopol gel, polyethylene glycol, and/or titanium dioxide, lacquer solutions, and suitable organic solvents or solvent mixtures. Dyestuffs or pigments can be added to the tablets or dragee coatings for product identification or to characterize the quantity of active compound (i.e., dosage).

For suppositories, binders and carriers include, for example, polyalkylene glycols or triglycerides; such suppositories can be formed from mixtures containing the active ingredient in the range of 0.5% to 10%, preferably 1%-2%. Oral formulations include excipients, such as pharmaceutical grades of mannitol, lactose, starch, magnesium stearate, sodium saccharine, cellulose, and magnesium carbonate. These compositions take the form of solutions, suspensions, tablets, pills, capsules, sustained release formulations or powders and contain 10%-95% of active ingredient, preferably 25%-70%.

Topical application can result in transdermal or intradermal delivery. Topical administration can be facilitated by co-administration of the agent with cholera toxin or detoxified derivatives or subunits thereof or other similar bacterial toxins. Glenn et al., Nature 391: 851, 1998. Co-administration can be achieved by using the components as a mixture or as linked molecules obtained by chemical crosslinking or expression as a fusion protein.

Alternatively, transdermal delivery can be achieved using a skin patch or using transferosomes. Paul et al., Eur. J. Immunol. 25: 3521-24, 1995; Cevc et al., Biochem. Biophys. Acta 1368: 201-15, 1998.

The pharmaceutical compositions are generally formulated as sterile, substantially isotonic and in full compliance with all Good Manufacturing Practice (GMP) regulations of the U.S. Food and Drug Administration.

The effective amount when referring to a therapeutic agent or compound or combination of therapeutic agents or compounds of the invention will generally mean the dose ranges, modes of administration, formulations, and the like, that have been recommended or approved by any of the various regulatory or advisory organizations in the medical or pharmaceutical arts (e.g., FDA, AMA) or by the manufacturer or supplier. Effective amounts can be found, for example, in the Physicians Desk Reference.

L. Kits

In another aspect, there are one or more kits for making and/or using the methods and reagents of the invention. The components of the kit are housed in a suitable container and can be sterile, where appropriate. Kit housing can include boxes, vials, or bottles, for example.

After the therapeutic agents of the invention are formulated in an acceptable carrier have been prepared as described above, they can be placed in an appropriate container and labeled for use to reduce the incidence, extent or severity of epilepsy or epilepsy-related diseases or conditions in a mammal comprising administering to the mammal prior to, concurrent with or after the onset of a condition expected to lead to epilepsy or epilepsy-related diseases or conditions an amount of therapeutic agent effective to attain said reduction.

In other aspects, there are components for application of the therapeutic agents to an individual, such as a syringe, a filter, an aqueous solution, a needle, a syringe, and so forth. A therapeutic product can include sterile saline or another pharmaceutically acceptable emulsion and suspension base as described above.

Kits of the present invention can also contain additional agents that can be administered concomitantly with the compounds of the present invention. In addition, kits can contain reagents or other components (e.g., the therapeutic agent can also be administered with at least one additional agent).

In addition, the kits can include instructional materials containing directions (i.e., protocols) for the practice of the methods of this invention. While the instructional materials typically comprise written or printed materials they are not limited to such. Any medium capable of storing such instructions and communicating them to an end user is contemplated by this invention. Such media include, but are not limited to electronic storage media (e.g., magnetic discs, tapes, cartridges, chips, and the like), optical media (e.g., CD ROM), and the like. Such media can include addresses to internet sites that provide such instructional materials.

The following Exemplary Aspects of specific aspects for carrying out the present invention are offered for illustrative purposes only, and are not intended to limit the scope of the present invention in any way.

### Exemplary Aspects

In one configuration, the patient may use the system shown in FIG. 12 to monitor the brain activity signals to assess the patient's susceptibility to a seizure. The system will typically be used to differentiate between a patient's contra-ictal condition, inter-ictal condition, and pro-ictal condition. The output communication may be any desired output that is indicative of the patient's condition. For example, in one configuration, the output communication may be selected from a green light (which corresponds to the contra-ictal condition), a yellow light (which corresponds to the inter-ictal condition), and a red light (which corresponds to the pro-ictal condition), or other outputs that indicate the patient's condition.

The platform of the present invention allows for flexible use of either acute dosing of a pharmacological agent or a titrated chronic dosing of a pharmacological agent. For example, in one embodiment, the patient may be instructed by their physician to only take an acute dosage of a pharmacological when the patient enters a pro-ictal condition so as to return the patient back to the inter-ictal condition, and preferably the contra-ictal condition. In other embodiments, the patient may be instructed by their physician to take only an acute dosage of a pharmacological when the patient leaves the contra-ictal condition and the small dosage may be used to return the patient back to their protected state. Additionally or alternatively, the patient may be instructed to take a first dosage when they transition from the contra-ictal condition to the inter-ictal condition, and if the first dosage doesn't affect the patient's trend, the patient may receive an output that indicates to them to take an additional first dosage or a second, larger dosage of the pharmacological agent.

In other embodiments, the patient may remain on a chronic dosing regimen. But instead of a constant dosage regimen, the patient will take dosages that are titrated to their condition. For example, the patient may take a small dosage to maintain their state in the contra-ictal condition. If the patient is determined to transition from the contra-ictal condition to an inter-ictal condition, the patient may be instructed by their physician to take a second dosage (typically larger than the first dosage) or adjust the timing of their scheduled dosages. In such embodiments, the external device may provide an output to the patient that indicates that the second dosage should be taken. Additionally or alternatively, if the patient is determined to transition from the inter-ictal condition into a pro-ictal condition, the patient may further be instructed by their physician to take a third dosage. As such the external device may provide an output to the patient that indicates that the third dosage should be taken.

For the patient's that are on a chronic dosing regimen, the external data device may be configured to provide a reminder communication to the patient at specified time in the day or days of the week to remind the patient to take their pharmacological agents. The communication to the patient will likely be indicative of the subject' real-time condition and/or the patient's historical condition over a previous time period. Such information may be used by the system (or the patient himself) to determine the appropriate dosage of the pharmacological agent. Thus, if the patient has been in a contra-ictal condition all (or a majority) of the time period, the patient will likely need only take a small, first dosage of the pharmacological agent (or no dosage at all). If however, the patient has been in or is currently in an inter-ictal condition, the patient will likely take a second dosage of the pharmacological agent. Finally, if the patient has been in or is in a pro-ictal condition, the patient will likely take the larger, third dosage of the pharmacological agent, or a different pharmacological agent altogether.

Each recited range described herein includes all combinations and sub-combinations of ranges, as well as specific numerals contained therein.

All publications and patent applications cited in this specification are herein incorporated by reference in their entirety for all purposes as if each individual publication or patent application were specifically and individually indicated to be incorporated by reference for all purposes.

Although the foregoing invention has been described in some detail by way of illustration and example for purposes of clarity of understanding, it will be readily apparent to one of ordinary skill in the art in light of the teachings of this invention that certain changes and modifications can be made thereto without departing from the spirit or scope of the appended claims.

What is claimed:

1. A method of modulating a drug response, the method comprising:
determining that a patient has an elevated susceptibility for a neurological event;
outputting a signal that indicates to the patient to administer an acute dosage of a pharmacological agent that is sufficient to modulate the patient's susceptibility for the neurological event,
wherein the drug response is modulated.

2. The method of claim 1 wherein the pharmacological agent is at least one antiepileptic drug (AED).

3. The method of claim 1 wherein the drug response is tolerance.

4. The method of claim 1 wherein the drug response is at least one side effect.

5. The method of claim 1 wherein the neurological event is an epileptic seizure.

6. The method of claim 1 wherein the pharmacological agent is a compound that modulates the sodium channels of a cell; a compound that modulates the sodium currents of a cell; a compound that modulates the calcium channels of a cell; a compound that modulates the calcium currents of a cell; a compound that modulates the potassium channels of a cell; a compound that modulates the potassium currents of a cell; a compound that modulates glutamic acid decarboxylase; a compound that binds to a gamma-aminobutyric acid receptor site; a compound that inhibits the metabolism of gamma-aminobutyric acid; a compound that inhibits the reuptake of gamma-aminobutyric acid; a compound that binds to a glutamate binding site; a compound that binds to an alpha-amino-3-hydroxy-5-methylisoxazole-4-propionic acid (AMPA) binding site; a compound that binds to a kainate binding site; a compound that binds to an N-methyl-D-aspartate (NMDA) binding site; a compound that binds to a glycine binding site; a compound that binds to a metabotropic binding site; a compound that is a natural or synthetic hormone; a compound that inhibits carbonic anhydrase; or a combination thereof.

7. The method of claim 1 wherein the pharmacological agent is a barbiturate; hydantoin; oxazolidinedione; succinimide; benzodiazepine; carboxamide; fatty acid derivative; fructose derivative; carboxylic acid; GABA analog; monosaccharide; aromatic allylic alcohol; urea; triazine; phenyltriazine; carbamate; pyrrolidine; pyrimidinedione; sulfonamide; valproic acid; valproate; valproylamide; propionate; aldehyde; bromide; or a combination thereof.

8. The method of claim 1 wherein the pharmacological agent is Barbexaclone, Metharbital, Methylphenobarbital, Phenobarbital, Primidone, Ethotoin, Fosphenyloin, Mephenyloin, Phenyloin, Ethadione, Paramethadione, Trimethadione, Ethosuximide, Mesuximide, Phensuximide, Clobazam, Clonazepam, Clorazepate, Diazepam, Lorazepam, Midazolam, Nitrazepam, Temazepam, Carbamazepine, Oxcarbazepine, Rufinamide, Valpromide, Valnoctamide, Valproic acid, Sodium Valproate, Valproate Semisodium, Tiagabine, Gabapentin, Pregabalin, Progabide, Vigabatrin, Topiramate, Stiripentol, Phenacemide, Pheneturide, Lamotrigine, Emylcamate, Felbamate, Meprobamate, Brivaracetam, Levetiracetam, Nefiracetam, Seletracetam, Acetazolamide, Ethoxzolamide, Sultiame, Methazolamide, Zonisamide, Beclamide, Paraldehyde, Potassium Bromide, Divalproex Sodium, Ganaxolone, Huperzine A, JZP-4, Lacosamide (SPM 927), NS1209, Retigabine, RWJ 333369, Talampanel, Eslicarbazepine acetate, Fluorofelbamate, Propylisopropyl acetamide, Valrocemide or a combination thereof.

9. A system for treating epilepsy, the system comprising:
an electrode array configured to receive a signal from a patient;
a processing assembly configured to receive and process the signal to determine the patient's susceptibility for a neurological event;
an output assembly configured to produce an output that indicates to the patient to administer an acute dosage of a pharmacological agent that is sufficient to reduce the patient's susceptibility for the neurological event,
wherein the drug response to the pharmacological agent is attenuated.

10. The system of claim 9 wherein the pharmacological agent is at least one antiepileptic drug (AED).

11. The system of claim 9 wherein the drug response is tolerance.

12. The system of claim 9 wherein the drug response is at least one side effect.

13. A method of modulating a drug response, the method comprising:
determining that a patient has an elevated susceptibility for a neurological event;
outputting a signal that indicates to the patient to adjust a parameter of a pharmacological agent that is sufficient to modulate the patient's susceptibility for the neurological event,
wherein the drug response is modulated.

14. The method of claim 13 wherein the pharmacological agent is at least one antiepileptic drug (AED).

15. The method of claim 13 wherein the pharmacological agent it taken chronically.

16. The method of claim 13 wherein the drug response is tolerance.

17. The method of claim 13 wherein the drug response is at least one side effect.

18. The method of claim 13 wherein the neurological event is a seizure.

19. The method of claim 13 wherein the pharmacological agent is a compound that modulates the sodium channels of a cell; a compound that modulates the sodium currents of a cell; a compound that modulates the calcium channels of a cell; a compound that modulates the calcium currents of a cell; a compound that modulates the potassium channels of a cell; a compound that modulates the potassium currents of a cell; a compound that modulates glutamic acid decarboxylase; a compound that binds to a gamma-aminobutyric acid receptor site; a compound that inhibits the metabolism of gamma-aminobutyric acid; a compound that inhibits the reuptake of gamma-aminobutyric acid; a compound that binds to a glutamate binding site; a compound that binds to an alpha-amino-3-hydroxy-5-methylisoxazole-4-propionic acid (AMPA) binding site; a compound that binds to a kainate binding site; a compound that binds to an N-methyl-D-aspartate (NMDA) binding site; a compound that binds to a glycine binding site; a compound that binds to a metabotropic binding site; a compound that is a natural or synthetic hormone; a compound that inhibits carbonic anhydrase; or a combination thereof.

20. The method of claim 13 wherein the pharmacological agent is a barbiturate; hydantoin; oxazolidinedione; succinimide; benzodiazepine; carboxamide; fatty acid derivative; fructose derivative; carboxylic acid; GABA analog; monosaccharide; aromatic allylic alcohol; urea; triazine; phenyltriazine; carbamate; pyrrolidine; pyrimidinedione; sulfonamide; valproic acid; valproate; valproylamide; propionate; aldehyde; bromide; or a combination thereof.

21. The method of claim 13 wherein the pharmacological agent is Barbexaclone, Metharbital, Methylphenobarbital, Phenobarbital, Primidone, Ethotoin, Fosphenyloin, Mephenyloin, Phenyloin, Ethadione, Paramethadione, Trimethadione, Ethosuximide, Mesuximide, Phensuximide, Clobazam, Clonazepam, Clorazepate, Diazepam, Lorazepam, Midazolam, Nitrazepam, Temazepam, Carbamazepine, Oxcarbazepine, Rufinamide, Valpromide, Valnoctamide, Valproic acid, Sodium Valproate, Valproate Semisodium, Tiagabine, Gabapentin, Pregabalin, Progabide, Vigabatrin, Topiramate, Stiripentol, Phenacemide, Pheneturide, Lamotrigine, Emylcamate, Felbamate, Meprobamate, Brivaracetam, Levetiracetam, Nefiracetam, Seletracetam, Acetazolamide, Ethoxzolamide, Sultiame, Methazolamide, Zonisamide, Beclamide, Paraldehyde, Potassium Bromide, Divalproex Sodium, Ganaxolone, Huperzine A, JZP-4, Lacosamide (SPM 927), NS1209, Retigabine, RWJ 333369, Talampanel, Eslicarbazepine acetate, Fluorofelbamate, Propylisopropyl acetamide, Valrocemide or a combination thereof.

22. A system for treating epilepsy, the system comprising:
an electrode array configured to receive a signal from a patient;
a processing assembly configured to receive and process the signal to determine the patient's susceptibility for a neurological event;
an output assembly configured to produce an output that indicates to the patient to administer an adjusted dosage of a pharmacological agent that is sufficient to reduce the patient's susceptibility for the neurological event,
wherein the drug response to the pharmacological agent is attenuated.

23. The system of claim 22 wherein the pharmacological agent is at least one antiepileptic drug (AED).

24. The system of claim 22 wherein the pharmacological agent is taken chronically.

25. The system of claim 22 wherein the drug response is tolerance.

26. The system of claim 22 wherein the drug response is at least one side effect.

27. A method of treating epilepsy, the method comprising:
estimating a patient's neurological condition;
determining if the patient's estimated condition is in a contra-ictal condition; and
when the patient is not in the contra-ictal condition, outputting a signal that indicates to a patient to administer one or more acute dosage(s) of a pharmacological agent that is sufficient to modulate the patient's neurological condition,
wherein the patient's susceptibility for a seizure is attenuated.

28. The method of claim 27 wherein the patient takes a chronic pharmacological agent to maintain the patient in a contra-ictal condition.
